(19) United States
(12) Patent Application Publication
(10) Pub. No.: US 2018/0343414 A1
(43) Pub. Date: Nov. 29, 2018

(54) FRAME BUFFERING TECHNOLOGY FOR CAMERA-INCLUSIVE DEVICES

(71) Applicant: QUALCOMM Incorporated, San Diego, CA (US)

(72) Inventors: Nitin Bandwar, San Diego, CA (US); Nishant Hariharan, San Diego, CA (US)

(21) Appl. No.: 15/603,179

(22) Filed: May 23, 2017

(51) Int. Cl. H04N 5/77; H04N 5/232

(52) U.S. Cl. CPC H04N 5/772; H04N 5/23293

(57) ABSTRACT

Frame buffering technologies are described. An example device includes camera hardware configured to receive a plurality of frames, a first memory device that implements a buffer, and a second memory device that consumes greater power than the first memory device. The device also includes processing circuitry coupled to the camera hardware, and to the first and second memory devices. The processing circuitry is configured to form a plurality of snapshot frames using a subset of the plurality of the received frames, to store the plurality of snapshot frames to the buffer implemented in the first memory device, and to receive a capture command. In response to receiving the capture command, the processing circuitry may identify, as a capture-selected snapshot frame, a first snapshot frame of the plurality of snapshot frames stored to the buffer, and push the capture-selected snapshot frame to the second memory device.

### TECHNICAL FIELD

This disclosure generally relates to image buffering, and more particularly, to buffering techniques of preview frames to support zero shutter lag (ZSL) technology.

### BACKGROUND

Digital camera technology has largely replaced film-based camera technology in recent years, and has become a virtually ubiquitous choice for the larger user base of photography equipment. Digital camera technology differs from film-based camera technology in that the image pickup components of digital cameras are electronic-based, instead of chemical-based in the case of film-based camera technology. Digital cameras (or “digicams”) are devices that encode digital images and videos in a storable format. Digital cameras capture and encode both digital still images and digital videos, the latter of which comprises so called “moving picture” data. With increasing device integration, digital camera technology is now commonly integrated into multi-use computing devices, such as smartphones, tablet computers, etc.

Whether implemented as a standalone digital camera, such as a digital single-lens reflex (DSLR) camera, or in the context of a more integrated device, digital camera technology has evolved to incorporate “zero shutter lag” (ZSL) capabilities. ZSL technology enables the digital camera to more accurately respond to a user command, by more accurately capturing a scene that the user attempted to photograph. ZSL technology is generally designed to compensate for lag time that may occur from an output time of a scene being via a display of the digital camera, until the digital camera finishes encoding and storing a picture in response to a “capture” command received from the user. The lag time may occur due to one or more factors, such as human reaction time, resource limitations of the digital camera, and various others.

A ZSL-enabled digital camera continually stores one or more of the frames most recently received from the photosensing hardware to a snapshot buffer of a memory device, for later retrieval and image processing in case a photo capture command is detected. To assist the user in selecting snapshots for capture, a ZSL-enabled digital camera also continually downsamples the received frames, and outputs the downsampled preview frames as a “preview stream” via a display device, to assist the user in selecting a corresponding snapshot for photo capture.

The user may provide a capture command in response to selecting a preview frame. As examples, to provide the capture command, the user may provide a tactile input via a touchscreen of the ZSL-enabled digital camera, or may actuate a physical button of the ZSL-enabled digital camera. In turn, upon processing the capture command received from a user, the ZSL-enabled digital camera selects one of the snapshots stored in the snapshot buffer, and further processes the selected snapshot for storing and presentation as a digital photograph. The ZSL-enabled digital camera selects the snapshot that corresponds to the user-selected preview frame. For instance, the ZSL-enabled digital camera may select the buffered snapshot that has a capture timestamp matching the capture timestamp of the user-selected preview frame.

In this way, ZSL-enabled digital cameras enable a more accurate photo capture in response to a user input to record a digital photograph. To compensate for commonly-exhibited lag times, many ZSL-enabled digicams continually buffer image data captured over the last one hundred fifty to two hundred ten milliseconds (150-210 ms). To support video frame rates provided by modern digital cameras, the buffering of image data for the last 150-210 ms typically causes the digital camera to maintain five to seven (5-7) uncompressed snapshot frames in the snapshot buffer at any given time.

### SUMMARY

This disclosure describes enhancements to ZSL-equipped digital cameras such that the snapshot buffer is implemented in more energy-efficient ways. As an example, enhanced ZSL-equipped digital cameras of this disclosure may implement the snapshot buffer in memory devices that consume less power than system memory, an example of which is double data rate (DDR) memory. According to some aspects of this disclosure, an enhanced ZSL-enabled digital camera of this disclosure implements the snapshot buffer in a dedicated memory device included in image signal processing front end (ISP-FE) hardware of the camera. According to other aspects of this disclosure, an enhanced ZSL-enabled digital camera of this disclosure implements the snapshot buffer in a last level cache (LLC) of the camera-inclusive device, such as a level 3 (L3) cache. As used herein, both the dedicated memory in the ISP-FE hardware as well as the LLC are examples of “on-chip memory.”

In one example, this disclosure is directed to a mobile computing device having digital camera capabilities. The mobile computing device includes camera hardware configured to receive a plurality of frames, a first memory device that implements a buffer, and a second memory device that consumes greater power than the first memory device. The mobile computing device also includes processing circuitry coupled to the camera hardware, to the first memory device, and to the second memory device. The processing circuitry is configured to form a plurality of snapshot frames using a subset of the plurality of the received frames, to store the plurality of snapshot frames to the buffer implemented in the first memory device, and to receive a capture command, and in response to receiving the capture command. In response to receiving the capture command, the processing circuitry is configured to identify, as a capture-selected snapshot frame, a first snapshot frame of the plurality of snapshot frames stored to the buffer implemented in the first memory device, and to push the capture-selected snapshot frame to the second memory device that consumes greater power than the first memory device.

In another example, this disclosure is directed to a method that includes receiving, by camera hardware of a mobile computing device, a plurality of frames, forming, by processing circuitry of the mobile computing device, a plurality of snapshot frames using a subset of the plurality of the frames received by the camera hardware; and storing, by the processing circuitry, the plurality of snapshot frames to a buffer implemented in a first memory device of the mobile computing device. The method further includes receiving, by the processing circuitry, a capture command, and in response to receiving the capture command: identifying, as a capture-selected snapshot frame, a first snapshot frame of the plurality of snapshot frames stored to the buffer implemented in the first memory device, and pushing, by the processing circuitry, the capture-selected snapshot frame to a second memory device of the mobile computing device, where the second memory device consumes greater power than the first memory device.

In another example, this disclosure is directed to an apparatus having digital camera capabilities. The apparatus includes means for receiving, via camera hardware of the apparatus, a plurality of frames, means for forming a plurality of snapshot frames using a subset of the plurality of the frames received by the camera hardware, and means for storing the plurality of snapshot frames to a buffer implemented in a first memory device of the apparatus. The apparatus further includes means for receiving a capture command, means for identifying, in response to receiving the capture command, a first snapshot frame of the plurality of snapshot frames stored to the buffer implemented in the first memory device as a capture-selected snapshot frame, and means for pushing, in response to receiving the capture command, the capture-selected snapshot frame to a second memory device of the apparatus, where the second memory device consumes greater power than the first memory device.

In another example, this disclosure is directed to a non-transitory computer-readable storage medium encoded with instructions. When executed, the instructions cause processing circuitry of a mobile computing device to receive, via camera hardware of a mobile computing device, a plurality of frames, to form a plurality of snapshot frames using a subset of the plurality of the frames received by the camera hardware, and to store the plurality of snapshot frames to a buffer implemented in a first memory device of the mobile computing device. The instructions, when executed, further cause the processing circuitry of the mobile computing device to receive a capture command, to identify, in response to the receipt of the capture command, a first snapshot frame of the plurality of snapshot frames stored to the buffer implemented in the first memory device as a capture-selected snapshot frame, and to push, in response to the receipt of the capture command, the capture-selected snapshot frame to a second memory device of the mobile computing device, where the second memory device consumes greater power than the first memory device.

The details of one or more examples of the techniques are set forth in the accompanying drawings and the description below. Other features, objects, and advantages of the techniques will be apparent from the description, drawings, and from the claims.

### BRIEF DESCRIPTION OF THE DRAWINGS

FIGS. 1A and 1B are block diagrams illustrating aspects of computing devices that include digital camera circuitry configured to perform various techniques of this disclosure.

FIG. 2A is a block diagram illustrating aspects of an example implementation of the system configuration of this disclosure illustrated in FIG. 1A.

FIG. 2B is a block diagram illustrating aspects of an example implementation of the system configuration of this disclosure illustrated in FIG. 1B.

FIG. 3A illustrates a timing diagram that shows performance frequency changes of double data rate (DDR) memory and a system bus as affected by DDR-voting aspects of traditional snapshot buffering techniques to support ZSL.

FIG. 3B illustrates a timing diagram that shows performance frequency changes of DDR memory and a system bus as affected by the modified DDR-voting aspects of this disclosure that ISP-FE circuitry may perform to reduce resource consumption while maintaining ZSL support.

FIG. 4 is a data flow diagram (DFD) illustrating an example of interactive operation of various hardware components configured to perform various aspects of the techniques described in this disclosure.

FIG. 5 is a flowchart illustrating an example process by which the mobile computing devices of FIGS. 1A and/or 1B may implement the snapshot buffering technologies of this disclosure to mitigate power drain on battery unit while supporting the user experience provided by ZSL.

FIG. 6 is a flowchart illustrating an example process by which the mobile computing devices of FIGS. 1A and/or 1B.

### DETAILED DESCRIPTION

This disclosure is generally directed to snapshot stream-oriented enhancements for ZSL-equipped digital cameras. Enhanced ZSL-equipped digital cameras of this disclosure may implement a snapshot buffer in a memory device that is separate from off-chip memory hardware of the ZSL-equipped digital camera or camera-inclusive device. ZSL-equipped digital cameras of this disclosure may implement the snapshot buffer in a memory device that consumes less power with respect to the buffering of uncompressed snapshot frames, such as one or more forms of on-chip memory. In some examples, a ZSL-equipped digital camera implements, initializes, or instantiates the snapshot buffer in a last level cache (LLC) of the camera or camera-inclusive device. An example of LLC memory is a level 3 (L3) cache. In other examples, the image signal processing front end (ISP-FE) of a ZSL-equipped digital camera includes dedicated memory hardware that includes the snapshot buffer. As used herein, both the LLC and the dedicated memory hardware included in the ISP-FE are examples of “on-chip memory.” That is, as used herein, an “on-chip memory” may, in one example, represent a system on a chip (SoC) that includes an LLC of the camera-inclusive device, or in another example, may represent a SoC that includes the ISP-FE hardware of the camera-inclusive device.

Because ZSL-equipped digital cameras store received frames at full resolution as snapshot frames, the snapshot frames have greater file sizes than the downsampled preview frames that are output to a user. With the ever-increasing image resolutions supported by digital cameras to meet consumer demand, the memory consumption and memory access frequency caused by snapshot buffering are also increasing commensurately. As such, snapshot buffering is becoming a more and more power-intensive process, due to more frequent accesses to off-chip memory of the camera inclusive device. That is, the process of snapshot buffering is become increasingly power-intensive because of frequent erase-and-write activity with respect to the off-chip memory resources and system bus infrastructure. Moreover, in many instances, a user may wait for a significant amount of time before providing a capture command, or may errantly leave the camera application of a mobile device (e.g., a mobile phone) active and not provide a capture command at all. In these scenarios, a ZSL-enabled digital camera may continue the “circular” buffering of full-resolution snapshot frames to the snapshot buffer, by erasing from and writing to the off-chip memory via system buses.

Factors such as those discussed above may result in faster battery drain, as well as greater burdens on system bus infrastructure and off-chip memory resources, stemming from the frequent erase-and-write activity with respect to the snapshot buffer being implemented in off-chip memory. For instance, the continual operations to maintain the most recent snapshot frames in the snapshot buffer causes a significant burden on the system buses and erase-and-write wear on flash cells of the off-chip memory implementing the snapshot buffer. Because of these factors, snapshot buffer maintenance represents a resource-heavy aspect of ZSL support.

Systems of this disclosure alleviate the resource consumption of snapshot buffering, while maintaining ZSL support. For instance, enhanced digital cameras constructed and configured according to aspects of this disclosure may initialize and implement the snapshot buffer in one or more forms of low-power memory devices, such as on-chip memory. By implementing the snapshot buffer in a low-power memory device, the systems of this disclosure may reduce various types of ZSL-related resource consumption, while still supporting ZSL performance. As examples of resource conservation, the systems of this disclosure may reduce one or more of power draw, system bus traffic, and flash cell wear in the system memory, an example of which is DDR memory. System memory (e.g., DDR) is an example of an off-chip memory device that, when operating at a high performance level or frequency, consumes greater power than the low-power memory devices described above. In this way, aspects of this disclosure provide enhanced ZSL-enabled digital camera technology, in that the systems of this disclosure may prolong battery life, free up system memory access to enable different device components to avail of the system memory, while maintaining ZSL support, and potentially spread memory wear more evenly.

A digital camera may implement ZSL-based snapshot buffering based on a user activation of certain functionalities. For example, if ZSL-enabled digital camera technology is integrated into a smartphone device, the digital camera's logic circuitry may activate snapshot buffering upon detecting that a user has activated a camera application, or “app,” on the smartphone. So long as the camera app is running, the digital camera may continually store full-resolution or near-full-resolution versions of the most recent five to seven (5-7) as snapshot frames in the snapshot buffer. Buffering the five to seven (5-7) most recent snapshot frames enables the digital camera-inclusive device to provide the user 150-210 ms worth of retroactive image data, thereby enabling the user to select a photo for capture while accounting for system and human delays. For ease of discussion, the systems of this disclosure are described with respect to a five-frame snapshot buffering scheme, although it will be appreciated that the systems of this disclosure are scalable to provide power-saving enhancements with respect to different snapshot buffering capacities, as well.

As discussed above, ZSL-enabled digital camera technology expends battery resources, taxes the system buses, and wears down flash memory cells of off-chip memory at a significant rate. Systems of this disclosure implement the snapshot buffer in a first memory device that consumes less power than the system memory device, thereby reducing the snapshot buffer-related use of system buses, power resources, and the system memory (e.g., one or more DDR memory devices). Digital cameras configured according to aspects of this disclosure may thereby maintain ZSL support while prolonging battery life, alleviating the wear on memory cells of system memory (e.g., DDR memory devices), and mitigating system bus burdens stemming from snapshot frame buffering. Additionally, the digital camera enhancements of this disclosure enable non-camera components of an integrated device (e.g., a smartphone) to more easily access the off-chip memory resources by reducing the snapshot buffering-related accesses to the off-chip memory. As such, the camera enhancements described herein provide various advantages over existing ZSL technology.

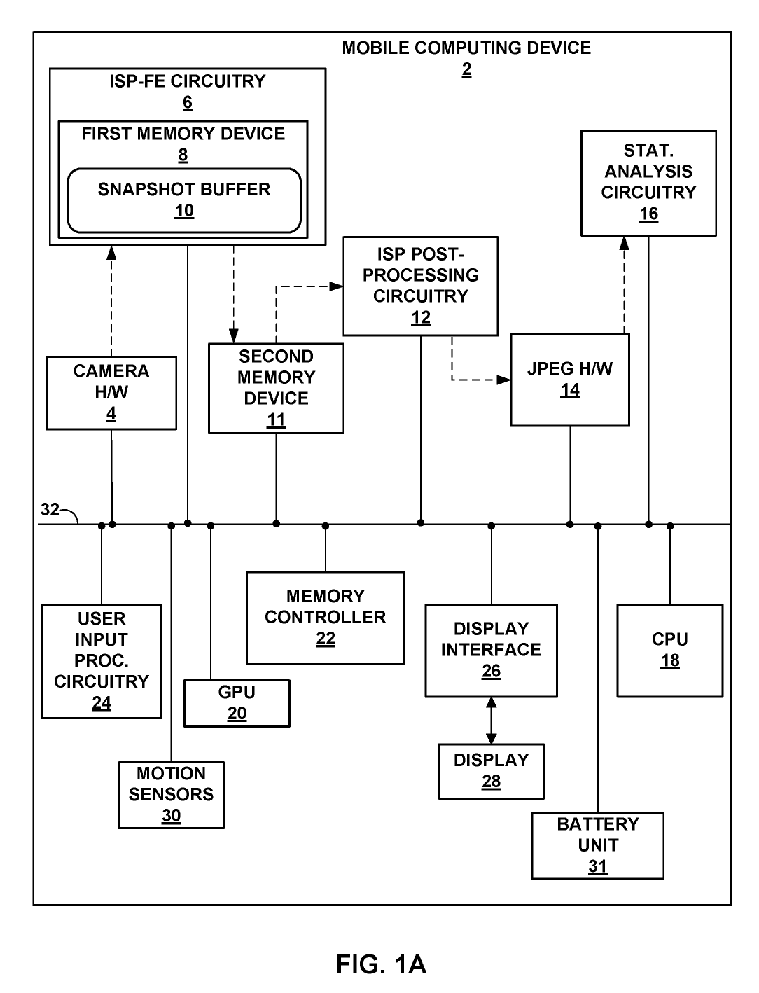

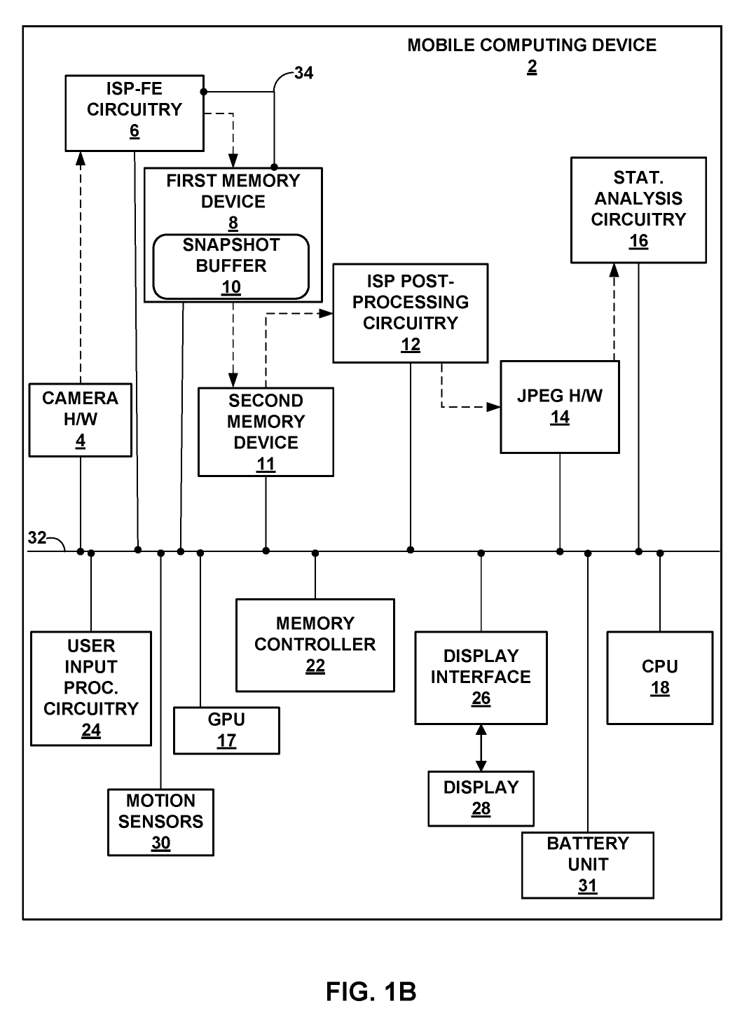

FIGS. 1A and 1B are block diagrams illustrating aspects of computing devices that include digital camera circuitry configured to perform various techniques of this disclosure. In the examples of FIGS. 1A and 1B (collectively, “FIGS. 1”), the computing device is labeled as mobile computing device 2. Mobile computing device 2 may include, be, or be part of various types of computing devices, such as a laptop computer, a wireless communication device or handset (such as, e.g., a mobile telephone, a cellular telephone, a so-called “smart phone” or “smartphone,” a satellite telephone, and/or a mobile telephone handset), a handheld device (such as a portable video game device or a personal digital assistant (PDA)), a tablet computer, a personal music player, a standalone digital camera (“digital camera”), a portable video player, a portable display device, or any other type of mobile device that includes camera-related circuitry to sense photos or other types of image data. While described with respect to mobile computing device 2, the techniques may be implemented by any type of device, whether considered mobile or not, such as by a desktop computer, a workstation, a set-top box, a television, or a webcam-inclusive monitor, to provide a few examples.

As illustrated in the example of FIG. 1, mobile computing device 2 includes camera hardware 4, image signal processing front end (ISP-FE) circuitry 6, first memory device 8, and second memory device 11. Second memory device 11 may consume greater power than first memory device 8, particularly if second memory device 11 is operating at a high performance level or frequency. For instance, the structure of second memory device 11, as well as the use of system bus architecture 32 to access second memory device 11, may cause second memory device 11 to consume greater power than first memory device 8. Second memory device 11 is an example of off-chip memory, in accordance with various aspects of this disclosure. In various use cases, second memory device 11 represents double data rate synchronous dynamic random-access memory (DDR SRAM). In the example of FIG. 1, first memory device 8 implements a snapshot buffer 10. First memory device 8 represents an example of on-chip memory, in accordance with various aspects of this disclosure.

Mobile computing device 2 further includes image signal processing post-processing (ISP-PP) circuitry 12, JPEG hardware 14, and statistical analysis circuitry 16. Mobile computing device 2 also includes a central processing unit (CPU) 18, graphical processing unit (GPU) 20, and a memory controller 22 that provides access to second memory device 11. As such, second memory device 11 may also represent an example of “system memory” of mobile computing device 2. Mobile computing device 2 also includes user input processing circuitry 24, a display interface 26 that outputs signals that cause graphical data to be visually output via display 28, one or more motion sensors 30, and a battery unit 31. Various circuitry components of mobile computing device 2 communicate with each other over an infrastructure of system buses, collectively shown as system bus architecture 32 in FIG. 1. It will be appreciated that, while illustrated in FIG. 1 as a single entity, system bus architecture 32 may, in various examples, represent varying numbers of buses that are directly or indirectly coupled to one another.

Although the various circuitry components are illustrated as separate, distinct circuitry components in FIG. 1, in some examples, two or more of the illustrated components may be combined to form a system on a chip (SoC). As an example, two or more of ISP-FE circuitry 6, ISP-PP circuitry 12, statistical analysis circuitry 16, and display interface 26 may be formed on a common chip. In other examples, two or more of ISP-FE circuitry 6, ISP-PP circuitry 12, statistical analysis circuitry 16, and display interface 26 may be formed on separate chips.

The various components illustrated in FIG. 1 may be formed in one or more microprocessors, application specific integrated circuits (ASICs), field programmable gate arrays (FPGAs), digital signal processors (DSPs), processing circuitry (including fixed function circuitry and/or programmable processing circuitry), or other equivalent integrated or discrete logic circuitry. As described above, second memory device 11 may include, be, or be part of double data rate synchronous dynamic RAM, which is a form of integrated circuits used to implement memory. Second memory device 11 may include any commercially-available class of DDR RAM integrated circuitry, including DDR4 SDRAM, or any of its slower-speed predecessors, namely, DDR3, DDR2, or DDR1 SDRAM integrated circuitry. As such, second memory device 11 may include, be, or be part of one or more memory devices that conform to DDR SDRAM technology of any generation. Again, second memory device 11 may consume greater power than first memory device 8, particularly at times when second memory device 11 is operating at a high performance frequency. In various examples, second memory device 11 represents an example of system memory or “off-chip memory” while first memory device 8 represents an example of “on-chip memory.”

As illustrated in FIG. 1, mobile computing device 2 also includes a battery unit 31. Although battery unit 31 is shown as a single unit in FIG. 1 for ease of illustration, it will be appreciated that battery unit 31 may represent one or more batteries and/or battery backup power supplies that may deliver electrical power to mobile computing device 2 and its various components. Battery unit 31 may represent power supplies that implement one or more of lithium-polymer technology, lithium ion technology, and various other technologies. Moreover, in some cases, battery unit 31 may encompass power supplies that are external to mobile device 2, such as a portable power bank that can interface with mobile computing device 2 via a multi-use port, such as a USB-C® or micro-USB® port.

Various circuitry components of mobile computing device 2 illustrated in FIG. 1 communicate with each other over system bus architecture 32. System bus architecture 32 may include, be, or be part of any of a variety of bus structures, such as a third generation bus (e.g., a HyperTransport bus or an InfiniBand bus), a second generation bus (e.g., an Advanced Graphics Port bus, a Peripheral Component Interconnect (PCI) Express bus, or an Advanced eXtensible Interface (AXI) bus) or another type of bus or device interconnect. It will be appreciated that the specific configuration of buses and communication interfaces between the different circuitry components shown in FIG. 1 is merely exemplary, and other configurations of computing devices and/or other image processing systems with the same or different components may be used to implement the techniques of this disclosure. Moreover, battery unit 31 is illustrated as being connected to system bus architecture 32 as an example, and in various examples, battery unit 31 may be connected to a power delivery system instead of being connected to system bus architecture 32.

Camera hardware 4 of mobile computing device 2 may include various image sensing hardware, other hardware that assists in image capture, circuitry configured to drive the camera sensor hardware, and processing circuitry for processing image data. As examples of image-sensing hardware, camera hardware 4 may include one or more lenses and one or more sensors. For instance, the sensors may include photodetector hardware, one or more amplifiers, one or more transistors, processing hardware, and complementary metal-oxide-semiconductor (CMOS) sensor hardware. Aspects of camera hardware 4 may incorporate photosensor elements having photoconductivity (e.g., the elements that sense light particles in the viewing spectrum or outside the viewing spectrum), and elements that can conduct electricity based on intensity of the light energy (e.g., infrared or visible light) striking their respective surfaces. Various elements of camera hardware 4 may be formed with germanium, gallium, selenium, silicon with dopants, or certain metal oxides and sulfides, as a few non-limiting examples.

In many use case scenarios, camera hardware 4 may include two or more sets of lens-sensor hardware that can, but do not necessarily, operate exclusively of each other. For instance, in some cases where mobile computing device 2 is a smartphone, camera hardware 4 may include a front-facing camera and a rear-facing camera. As examples of capture-assisting hardware, camera hardware 4 may incorporate one or more light-emitting devices, such as a flash unit that includes a photoflash light-emitting diode (LED), or illumination-providing components of display 28 that double as a flash unit with respect to a front-facing camera of camera hardware 4.

As described above, camera hardware 4 includes processing circuitry configured to perform some amount of image processing on sensed image data. For instance, the processing circuitry of camera hardware 4 may include image generation circuitry, which generates raw image data based on data sensed by the sensor hardware and optionally enhanced by other components, such as flash unit(s) of camera hardware 4. Upon generating the raw data for a sensed image, camera hardware 4 may provide the raw image to ISP-FE circuitry 6. An image that is output by camera hardware 4 is referred to herein as a “raw image” even though it will be understood that camera hardware 4 and its components may implement some level of image processing during image generation or at another stage before outputting the image to ISP-FE circuitry 6. Camera hardware 4 may provide the raw images to ISP-FE circuitry 6 using system bus architecture 32. As such, the dashed-line arrow going from camera hardware 4 to ISP-FE circuitry 6 represents a logical data path, although it will be understood that camera hardware 4 communicates the raw image data to ISP-FE circuitry 6 via system bus architecture 32 and/or other bus architecture of the mobile computing device 2.

ISP-FE circuitry 6 represents hardware configured to refine raw image data received from camera hardware 4. ISP-FE circuitry 6 may include, be, or be part of one or more of application specific integrated circuits (ASICs), field programmable gate arrays (FPGAs), digital signal processors (DSPs), processing circuitry (including fixed function circuitry and/or programmable processing circuitry), or other equivalent integrated circuitry or discrete logic circuitry. In some examples, portions of ISP-FE circuitry 6 may be referred to as a “video front end” or “VFE” engine.

ISP-FE circuitry 6 may refine or “touch up” a raw image received from camera hardware 4, and may also extract descriptive information or “metadata” with respect to the image. To refine an image received from camera hardware 4, ISP-FE circuitry 6 may apply one or more filters to sharpen the image, such as automatic varifocal filtering (AVF), pixelwise dark channel prior (PDCP) filters, and other filters. ISP-FE circuitry 6 may also implement noise reduction or noise removal, de-mosaicing, black level correction, pixel correction (e.g., to identify faulty pixels and then predict the faulty pixels from neighboring pixels), and/or color conversion. Generally, ISP-FE circuitry 6 may apply de-mosaicing to update the color and brightness of image pixels.

According to existing ZSL technology, ISP-FE circuitry 6 may store one or more of these touched-up images to second memory device 11. For instance, ISP-FE circuitry 6 may support ZSL, by continually storing the touched-up images to second memory device 11, or more specifically, to a “circular” buffer that is implemented in second memory device 11. That is, according to existing ZSL technology, ISP-FE circuitry 6 would continually store a subset of the most-recently refined images as full-resolution snapshot frames to second memory device 11. In various use cases according to existing ZSL technology, ISP-FE circuitry 6 would continually store some (e.g. five) of the most-recently refined images to second memory device 11, by communicating with second memory device 11 over system bus architecture 32. As such, the dashed-line arrow from ISP-FE circuitry 6 to second memory device 11 represents a logical data path, although it will be understood that ISP-FE circuitry 6 “pushes” the touched-up images to second memory device 11 via system bus architecture 32. Again, according to existing ZSL technology, ISP-FE circuitry 6 may touch up every frame received from camera hardware 4, and push every touched-up frame via system bus architecture 32 to second memory device 11.

For instance, ISP-FE circuitry 6 may support ZSL technology by implementing an erase-and-write scheme by which ISP-FE circuitry 6 maintains a set of images reflecting frames received from camera hardware 4 over the last 150-210 milliseconds, in accordance with an implementation in which camera hardware 4 implements a thirty frames per second (30 fps) frame rate. By continually writing the five most-recently processed images to second memory device 11 over system bus architecture 32, ISP-FE circuitry 6 may support ZSL according to existing techniques by enabling other components of mobile computing device 2 to respond to a “capture” command by selecting a buffered snapshot frame that accurately represents a scene that a user attempted to photograph.

Because ISP-FE circuitry 6 continually writes the five most-recently processed images as snapshot frames to snapshot buffer 10, snapshot buffer 10 may be referred to as a “circular” buffer. That is, the term “circular” describes the continual updating of the stored set of snapshot frames on a first-in-first-out (FIFO) basis. Expressed in another way, the circular buffering scheme that ISP-FE circuitry 6 implements with respect to snapshot buffer 10 may be described as a queue, in that queues follow a FIFO order of replacement.

For instance, user input processing circuitry 24 may process a user input that reflects a capture command. In examples where mobile computing device 2 is a smartphone and display 28 is an input/output capable device, such as a touchscreen, user input processing circuitry 24 may receive data over system bus architecture 32 that indicates receipt of a “click” on a capture button displayed via display 28. In other examples, whether mobile computing device 2 represents a smartphone, standalone digital camera, or other device, user input processing circuitry 24 may detect the capture command based on an actuation of a physical button. Upon detecting a capture command, and optionally, discerning a timestamp associated with the receipt of the command, user input processing circuitry 24 may cause CPU 18 to retrieve one of the three currently-stored images from snapshot buffer 10 for further processing and storage as a user-identified photograph.

As described above, in a 30 fps frame rate implementation, ISP-FE circuitry 6 may buffer a sufficient number (in one example, five) of the most recently processed snapshot frames in second memory device 11, using system bus architecture 32 to communicate the erase and write commands to be executed at second memory device 11. Again, ISP-FE circuitry 6 may store different numbers of frames in snapshot buffer 10 to support different frame rates, but the 150-210 ms buffering at 30 fps frame rate example is used throughout this disclosure purely for illustrative purposes. In examples where camera hardware 4 supports image resolutions that in the order of tens of megapixels, ISP-FE circuitry 6 may implement not only frequent, but relatively data-rich erase-and-write operations in second memory device 11 to support ZSL, according to existing ZSL technology. For instance, many cameras that are available commercially support image resolutions as high as twenty-one megapixels (21MP). Several portions of this disclosure use examples and experimental results in which camera hardware 4 supports image resolutions in the range of thirteen megapixels to sixteen megapixels (13MP-16MP), which may represent a relatively low or even minimal resolution provided by camera technology that is commercially available at the time of this disclosure.

To support ZSL according to existing technology in a 30 fps frame rate, 13MP-16MP image resolution implementation, ISP-FE circuitry 6 may expend significant resources of mobile computing device 2. Examples of the resource-heavy characteristics of existing ZSL technology include a faster drain of energy resources available from battery unit 31, bandwidth consumption over system bus architecture 32, and concentrated wear on the flash cells of second memory device 11 (e.g., without sharing the flash cell wear with memory resources other than second memory device 11). Again, to support ZSL using existing techniques, ISP-FE circuitry 6 may expend significant resources with respect to battery unit 31, system bus architecture 32, and second memory device 11 by frequently erasing and writing 13MP-16MP image data at a 30 fps frame rate. As described above, second memory device 11 consumes greater power than first memory device 8, particularly in instances where second memory device 11 is controlled by CPU 18 to operate at a high performance frequency. The battery drain, system bus traffic congestion, and concentrated memory wear caused by existing ZSL support techniques may even become wasteful or excessive in some cases, such as if a user of mobile computing device 2 unintentionally leaves a camera application (or “app”) activated after finishing capturing all desired still photographs or videos.

As discussed above, CPU 18 may select a buffered snapshot frame in response to processing a capture command relayed by user input processing circuitry 24. For instance, according to existing ZSL support techniques, CPU 18 may select a snapshot frame from second memory device 11 for further processing and storage as a user-captured photograph. Based on CPU 18 selecting a snapshot frame, ISP post-processing (ISP-PP) circuitry 12 may access the selected snapshot frame from second memory device 11, for further processing. ISP-PP circuitry 12 may extract the selected snapshot frame from second memory device 11 using system bus architecture 32. That is, the dashed-line arrow from second memory device 11 to ISP-PP circuitry 12 represents a logical data path with respect to selected snapshot frames, although it will be understood that the selected snapshot frames are communicated to ISP-PP circuitry 12 via system bus 12 and/or other bus architecture of mobile computing device 2. ISP-PP circuitry 12 may further refine the selected image, in addition to the initial touch-ups applied by ISP-FE circuitry 6. In contrast to ISP-FE circuitry 6, which represents “front end” processing circuitry with respect to image processing performed at mobile computing device 2, ISP-PP circuitry 12 represents “back end” processing circuitry. That is, while ISP-FE circuitry 6 applies image processing (e.g., filters) on all frames received from camera hardware 4. In contrast, ISP-PP circuitry 12 processes only those images that CPU 18 has already selected for processing and storage as a user-captured photograph. In various examples ISP-PP circuitry 12 may be referred to as camera post-processing (CPP) circuitry, or as an “ISP post-proc” unit or engine.

Again, in response to a picture selection performed by CPU 18, ISP-PP circuitry 12 may extract the selected picture from second memory device 11, according to existing ZSL technology. In turn, ISP-PP circuitry 12 may further condition the extracted snapshot frame for use as a captured photograph. For instance, ISP-PP circuitry 12 may apply noise reduction and sharpening to the to the extracted picture. Moreover, ISP-PP circuitry 12 may apply additional filtering to the extracted picture, to further refine the picture beyond the front-end filtering applied by ISP-FE circuitry 6. As such, ISP-PP circuitry 12 may apply a different set of filters from a set of filters applied by ISP-FE circuitry 6. As examples, ISP-PP circuitry 12 may apply sharpness filters, such as one or more of an adaptive spatial filtering (ASF), wavelet noise reduction, and temporal noise reduction. ISP-PP circuitry 12 may be configured with rotation capabilities and thus, ISP-PP circuitry 12 may also compute inverse transformations for individual pixels of the extracted picture.

The various filtering technologies that ISP-PP circuitry 12 is configured to apply may represent relatively resource-heavy or resource-intensive filtering techniques in comparison to the front-end filtering techniques applied by ISP-FE circuitry 6. For this reason, ISP-PP circuitry 12 implements the above discussed filters as part of back-end filtering. More specifically, by reserving the resource-intensive filter sets for back-end implementation, ISP-PP circuitry 12 may limit the resource-intensive (e.g., processor-intensive) filtering techniques to be applied only to select pictures that have been identified for further refining and storage. In this way, ISP-PP circuitry 12 may reduce the burden on one or more of CPU 18, GPU 20, and other hardware of mobile computing device 2 by reserving certain filtering techniques for back-end implementation only with respect to select pictures.

ISP-PP circuitry 12 may provide the processed snapshot frame to JPEG hardware 14 for further refinement and processing. ISP-PP circuitry 12 may extract the selected snapshot frame from second memory device 11 using system bus architecture 32. That is, the dashed-line arrow from second memory device 11 to ISP-PP circuitry 12 represents a logical data path with respect to the filtered snapshot frames, although it will be understood that the filtered snapshot frames are communicated to JPEG hardware 14 via system bus architecture 32 and/or other system bus architecture of mobile computing device 2.

In turn, JPEG hardware 14 may provide the processed picture to statistical analysis circuitry 16. Statistical analysis circuitry 16 may include, be, or be part of one or more of application specific integrated circuits (ASICs), field programmable gate arrays (FPGAs), digital signal processors (DSPs), processing circuitry (including fixed function circuitry and/or programmable processing circuitry), or other equivalent integrated circuitry or discrete logic circuitry.

Statistical analysis circuitry 16 may be configured to extract and/or analyze descriptive information, or so-called “metadata” with respect to the processed snapshot frame received from JPEG hardware 14. For instance, statistical analysis circuitry 16 may extract statistical data, also referred to as statistics or “stats” from the picture. Statistical analysis circuitry 16 may provide the extracted statistical data to other components of mobile computing device 2, to enable the other components to analyze various characteristics of captured photograph. Examples of statistical data or metadata that statistical analysis circuitry 16 may extract from a photograph include color transitions, motion blur, changes in white balance, sharpness changes (sharpening or dulling), red-green-blue (RGB) filtering gains (in accordance with a Bayer filter), and various other image characteristics.

In various use cases, camera hardware 4 need not necessarily be part of mobile computing device 2, and may be external to mobile computing device 2. In such examples, camera hardware 4 may be communicatively coupled to ISP-FE circuitry 6, by wired or wireless means. For ease of discussion and illustration, however, examples of this disclosure are described with respect to camera hardware 4 being part of mobile computing device 2 (e.g., such as in examples where mobile computing device 2 is a smartphone, tablet computer, handset, mobile communication handset, standalone digital camera, or the like).

CPU 18 may include, be, or be part of general-purpose or special-purpose processing circuitry that controls operation of various components of mobile computing device 2 of FIG. 1. A user may provide input via user to mobile computing device 2 to cause CPU 18 to execute one or more software applications. Software applications executing within the execution environment provided by CPU 18 may include, for example, an operating system, a camera application, a camcorder application, a word processor application, an email application, a spread sheet application, a media player application, a video game application, a graphical user interface application, or any another program. The user may provide input to mobile computing device 2 via one or more input devices such as a keyboard, a mouse, a microphone, a touch pad, a touch-sensitive screen, physical input buttons, virtual input button buttons output via a touch-sensitive or stylus-activated display, or another input device that is coupled to mobile computing device 2 via user input processing circuitry 24.

As one example, user input may cause CPU 18 to execute a camera/camcorder application to capture a still photograph or video file, by leveraging one or more of camera hardware 4, ISP-FE circuitry 6, ISP-PP circuitry 12, JPEG hardware 14, or statistical analysis circuitry 16. An active camera application may present real-time image content as downsampled “preview frames” via display 28 for the user to view prior to capturing a digital photograph. Again, ISP-FE circuitry 6 may perform front-end filtering of full-resolution versions of the real-time frame content received from camera hardware 4. The code for the camera application used to capture images may be stored on second memory device 11. CPU 18 may retrieve and execute object code corresponding to the camera application's code stored to second memory device 11. Alternatively, CPU 18 may retrieve source code from second memory device 11, and may compile the source code to obtain the object code corresponding to the camera application. In turn, CPU 18 may execute the object code to present visual (and potentially, audiovisual) data for the camera application via display 28 and optionally, one or more speakers (not shown).

CPU 18 may also implement an ISP kernel driver to operate ISP-FE circuitry 6 and/or ISP-PP 12. For ease of discussion, portions of this disclosure describe ISP-FE circuitry 6 performing buffering techniques, whether with respect to traditional ZSL technology, or with respect to the enhanced ZSL buffering techniques of this disclosure. It will be appreciated that, in some instances, various functionalities that are described as being performed by ISP-FE 6 may be based on instructions executed by the ISP kernel driver running on CPU 18.

Upon monitoring the preview frames output via display 28, the user may interact, such as by actuating a graphical button output via display 28 to capture a full-resolution version of the viewed preview frame as a digital photograph. In response, ISP-PP circuitry 12 may extract a snapshot frame (that corresponds to the preview frame displayed at the time of the capture command) from snapshot buffer 10, process the retrieved snapshot frame, and forward the processed snapshot frame to JPEG hardware 14. Memory controller 22 facilitates the transfer of data going into and out of second memory device 11. For example, memory controller 22 may receive memory read and write commands, and service such commands with respect to second memory device 11 in order to provide memory services for the components in mobile computing device 2. Memory controller 22 is communicatively coupled to second memory device 11, such as via system bus 2. Although memory controller 22 is illustrated in the example mobile computing device 2 of FIG. 1 as being a unit that is separate and distinct from both CPU 18 and second memory device 11, in other examples, some or all of the functionality of memory controller 22 may be implemented on one or both of CPU 18 or second memory device 11.

In some aspects, second memory device 11 may include instructions that cause one or more of camera hardware 4, ISP-FE circuitry 6, GPU 17, ISP-PP circuitry 12, JPEG hardware 14, statistical analysis circuitry 16, user input processing circuitry 24, display interface 26, or motion sensors 30 to perform the functions ascribed to these components in this disclosure. Accordingly, second memory device 11 may include system memory that represents a computer-readable storage medium having instructions stored thereon that, when executed, cause one or more processors (e.g., GPU 17, CPU 18, user input processing circuitry 24, or display interface 26) to perform various aspects of the techniques described in this disclosure.

In some examples, second memory device 11 may represent a non-transitory computer-readable storage medium. The term “non-transitory” indicates that the storage medium is not embodied in a carrier wave or a propagated signal. However, the term “non-transitory” should not be interpreted to mean that second memory device 11 is non-movable or that its contents are static. As one example, second memory device 11 may be removed from device 2, and moved to another device. As another example, memory, substantially similar to second memory device 11, may be inserted into device 2. In certain examples, a non-transitory storage medium may store data that can, over time, change (e.g., in RAM).

GPU 17, CPU 18, and user input processing circuitry 24, may store image data, and the like in respective buffers that are allocated within to second memory device 11. Display interface 26 may retrieve the data from second memory device 11 and configure display 28 to display the image represented by the rendered image data. In some examples, display interface 26 may include a digital-to-analog converter (DAC) that is configured to convert the digital values retrieved from second memory device 11 into an analog signal consumable by display 28. In other examples, display interface 26 may pass the digital values directly to display 28 for processing.

Display 28 may include a monitor, a television, a projection device, a liquid crystal display (LCD), a plasma display panel, a light emitting diode (LED) array, a cathode ray tube (CRT) display, electronic paper, a surface-conduction electron-emitted display (SED), a laser television display, a nanocrystal display or another type of display unit. Display 28 may be integrated within mobile computing device 2. For instance, display 28 may be a screen of a mobile telephone handset, a tablet computer, or a standalone digital camera. Alternatively, display 28 may be a standalone device coupled to mobile computing device 2 via a wired or wireless communications link. For instance, display 28 may be a computer monitor or flat panel display connected to mobile computing device 2 via a cable or wireless link.

Each of FIGS. 1A and 1B illustrates a respective implementation of the digital camera enhancements of this disclosure. As discussed above, this disclosure is generally directed to snapshot stream-oriented enhancements that enable digital cameras and digital camera-inclusive devices to provide ZSL support while reducing the power drain burdens on battery unit 31, reducing bandwidth congestion on system bus architecture 32, and alleviating the flash cell wear burdens on second memory device 11. In the example of FIG. 1A, ISP-FE circuitry 6 includes first memory device 8. That is, in the implementation illustrated in FIG. 1A, first memory device 8 represents a memory device that is included within ISP-FE circuitry 6, and operates within ISP-FE circuitry 6.

Examples of first memory device 8 include one or more volatile or non-volatile memories or storage devices, such as, e.g., cache memory, static RAM (SRAM), dynamic RAM (DRAM), etc. Because ISP-FE circuitry 6 includes a combination of processing circuitry and memory (in the form of first memory device 8), ISP-FE circuitry 6 may, in some examples, represent a SoC.

In the example implementation illustrated in FIG. 1A, ISP-FE circuitry 6 may apply front end filtering to touch up all images received from camera hardware 4, as described above. In contrast to existing ZSL techniques, however, the ISP-FE circuitry 6 may continually store the touched-up versions of the five most recently received frames, to first memory device 8. That is, according to the system implementation of this disclosure illustrated in FIG. 1A, ISP-FE circuitry 6 implements snapshot buffer 10 locally, because in this implementation, first memory device 8 is included within ISP-FE circuitry 6. By implementing snapshot buffer 10 locally in first memory device 8, ISP-FE circuitry 6 may avoid using system bus architecture 32 on a continual basis for snapshot buffering prior to receiving a capture command from user input processing circuitry 24. Instead, according to the implementation illustrated in FIG. 1A, ISP-FE circuitry 6 may use on-chip memory (OCM) bus architecture to implement the circular buffering of touched-up images to snapshot buffer 10 as snapshot frames. By using the OCM bus architecture to perform continual circular buffering to snapshot buffer 10 in first memory device 8, ISP-FE circuitry 6 may avoid using system bus architecture 32 to implement the circular buffering of the snapshot frames. ISP-FE circuitry 6 may thereby make the finite bandwidth provided by system bus architecture 32 more available to other components of mobile computing device 2, while avoiding negatively impacting ZSL support.

Moreover, the implementation of this disclosure illustrated in FIG. 1A represents a more energy-efficient system than existing ZSL-enabled cameras or camera-inclusive devices. Because ISP-FE circuitry 6 implements the continual circular buffering of touched-up images to snapshot buffer 10 in first memory device 8, ISP-FE circuitry 6 alleviates the energy expenditure (e.g., from battery unit 31) that would otherwise occur if ISP-FE circuitry 6 were perform the circular buffering over system bus architecture 32. For instance, the repeated erase-and-write operations required to implement the circular buffering of snapshot frames to snapshot buffer 10 may be more power-intensive when performed over system bus architecture 32, which may represent higher-performance (and therefore less power-efficient) hardware than an OCM bus or other internal communications architecture of ISP-FE circuitry 6. As described above, second memory device 11 consumes greater power than first memory device 8, due to second memory device 11 being accessed via system bus architecture 32, and for other reasons.

Additionally, the system configuration of this disclosure that is illustrated in FIG. 1A may enable ISP-FE circuitry 6 to reduce the wear on memory cells (e.g., flash cells) of second memory device 11. For instance, according to the system configuration of FIG. 1A, ISP-FE circuitry 6 may shift at least a portion of the flash cell wear burden of ZSL support from second memory device 11 to first memory device 8. In this way, ISP-FE circuitry 6 may prolong the life of second memory device 11, which represents DDR memory that various system components of mobile computing device 2 may use as system memory.

Upon detecting a photograph capture command received at and/or relayed by user input processing circuitry 24, ISP-FE circuitry 6 may select a snapshot frame from snapshot buffer 10 for further processing. In some examples, ISP-FE circuitry 6 may select a particular snapshot frame from snapshot buffer 10, based on matching a timestamp of the snapshot frame to a receipt timestamp of the capture command. In other examples, ISP-FE circuitry 6 may select the snapshot frame based on matching the timestamp of the snapshot frame to a timestamp for a preview frame that was output via display 28 at the time when the capture command was received at user input processing circuitry 24.

In turn, ISP-FE circuitry 6 may transfer or “push” the selected snapshot frame to second memory device 11. That is, ISP-FE circuitry 6 may implement the techniques of this disclosure to tax system bus architecture 32 for operations involving snapshot buffer 10, only in the case that ISP-FE circuitry 6 receives an indication of a capture command. Particularly in scenarios where a user waits for a significant length of time before providing a capture command, or in which a camera app is unintentionally invoked or left active, the capture-responsive snapshot push techniques of this disclosure may eliminate the bandwidth consumption over system bus architecture 32 that would occur according to existing ZSL technology. Moreover, the capture-responsive snapshot push techniques of this disclosure may alleviate the power drain imposed on battery unit 31 that would occur according to existing ZSL technology in these scenarios. As such, according to the system configuration illustrated in FIG. 1A, ISP-FE circuitry 6 may slow the drain of battery unit 31 and release bandwidth resources of system bus architecture 32 to other hardware components of mobile computing device 2, while not diminishing the ZSL support provided by mobile computing device 2.

FIG. 1B illustrates another example implementation of the snapshot stream-oriented system enhancements of this disclosure. In the example of FIG. 1B, first memory device 8 is positioned and implemented externally to ISP-FE circuitry 6. According to various implementations that are represented by the system configuration illustrated in FIG. 1B, first memory device 8 may represent various types of memory devices that are part of existing device architectures. For example, first memory device 8 as illustrated in FIG. 1B may include, be, or be part of a last level cache (LLC) of mobile computing device 2. That is, in cases where first memory device 8 represents an LLC of mobile computing device 2, first memory device 8 may fit certain criteria for classification in a particular (e.g., “last”) level of a multi-level cache classification scheme. In some examples represented by the system configuration illustrated in FIG. 1B, first memory device 8 may be a level 3 (L3) cache of mobile computing device 2. Examples of first memory device 8 include one or more volatile or non-volatile memories or storage devices, such as, e.g., random access memory (RAM), static RAM (SRAM), dynamic RAM (DRAM), erasable programmable ROM (EPROM), electrically erasable programmable ROM (EEPROM), flash memory, a magnetic data media or an optical storage media. In some instances, first memory device 8 may be included within CPU 18, as a CPU cache memory, for example. Second memory device 11 represents an example of off-chip memory, while first memory device 8 represents an example of on-chip memory, in accordance with various aspects of this disclosure.

While several different system configurations of this disclosure are compatible with the schematic illustrated in FIG. 1B, FIG. 1B is described herein with respect to first memory device 8 being an L3 cache, as an example for discussion. Based on the hierarchical classification of ‘L3’ status for first memory device 8, several multimedia cores of mobile computing device 2 may use first memory device 8 using multimedia bus architecture of mobile computing device 2. The multimedia bus architecture may be different and separate from system bus architecture 32. For instance, the multimedia bus architecture of mobile computing device 2 may include an on-chip memory (OCM) bus 34. While OCM bus 34 is illustrated in FIG. 1B as representing a direct physical connection between ISP-FE circuitry 6 and first memory device 8 for ease of illustration, it will be appreciated that OCM bus 34 may connect or couple various multimedia cores of mobile computing device 2 to first memory device 8, through direct connections or transitive connections.

In the example implementation illustrated in FIG. 1B, ISP-FE circuitry 6 may apply front end filtering to touch up all frames received from camera hardware 4, as described above. In contrast to existing ZSL techniques, however, the ISP-FE circuitry 6 may continually store the touched-up versions of the five most recently received frames, to first memory device 8, via OCM bus 34. As described above, OCM bus 34 may couple ISP-FE circuitry 6 to first memory device 8. The operation of ISP-FE circuitry writing snapshot frames to snapshot buffer 10 of first memory device 8 is illustrated in FIG. 1B using a dashed-line arrow. By performing the erase-and-write operations associated with the circular buffering of touched-up snapshot frames to snapshot buffer 10 over OCM bus 34, ISP-FE circuitry 6 may avoid using system bus architecture 32 on a continual basis for snapshot buffering prior to receiving a capture command from user input processing circuitry 24. By avoiding the use of system bus architecture 32 to implement the circular buffering of the snapshot frames, ISP-FE circuitry 6 may make the finite bandwidth provided by system bus architecture 32 more available to other components of mobile computing device 2, while maintaining ZSL support without a diminishment in ZSL-related performance.

Moreover, the implementation of this disclosure illustrated in FIG. 1B represents a more energy-efficient system than existing ZSL-enabled cameras or camera-inclusive devices. Because ISP-FE circuitry 6 implements the continual circular buffering of touched-up images to snapshot buffer 10 over OCM bus 34, ISP-FE circuitry 6 alleviates the energy expenditure (e.g., from battery unit 31) that would otherwise occur if ISP-FE circuitry 6 were perform the circular buffering over system bus architecture 32. For instance, the repeated erase-and-write operations required to implement the circular buffering of snapshot frames to snapshot buffer 10 may be more power-intensive when performed over system bus architecture 32, which may represent higher-performance (and therefore less power-efficient) hardware than OCM bus 34. As described above, second memory device 11 consumes greater power than first memory device 8, due to the use of system bus architecture 32 to access second memory device 11, and for other reasons as well.

Additionally, the system configuration of this disclosure that is illustrated in FIG. 1B may enable ISP-FE circuitry 6 to reduce the wear on memory cells (e.g., flash cells) of second memory device 11. For instance, according to the system configuration of FIG. 1B, ISP-FE circuitry 6 may shift at least a portion of the flash cell wear burden of ZSL support from second memory device 11 to first memory device 8. In this way, ISP-FE circuitry 6 may prolong the life of second memory device 11, which represents DDR memory that various system components of mobile computing device 2 may use as system memory.

Upon detecting a photograph capture command received at and/or relayed by user input processing circuitry 24, ISP-FE circuitry 6 may select a snapshot frame from snapshot buffer 10 for further processing. In some examples, ISP-FE circuitry 6 may select a particular snapshot frame from snapshot buffer 10, based on matching a timestamp of the snapshot frame to a receipt timestamp of the capture command. In other examples, ISP-FE circuitry 6 may select the snapshot frame based on matching the timestamp of the snapshot frame to a timestamp for a preview frame that was output via display 28 at the time when the capture command was received at user input processing circuitry 24.

In turn, ISP-FE circuitry 6 may transfer the selected snapshot frame from first memory device 8 to second memory device 11. That is, ISP-FE circuitry 6 may implement the techniques of this disclosure to tax system bus architecture 32 for operations involving snapshot buffer 10, only in the case that ISP-FE circuitry 6 receives an indication of a capture command. Particularly in scenarios where a user waits for a significant length of time before providing a capture command, or in which a camera app is unintentionally invoked or left active, the capture-responsive snapshot push techniques of this disclosure may eliminate the bandwidth consumption over system bus architecture 32 that would occur according to existing ZSL technology. Moreover, the capture-responsive snapshot push techniques of this disclosure may alleviate the power drain imposed on battery unit 31 that would occur according to existing ZSL technology in these scenarios. As such, according to the system configuration illustrated in FIG. 1B, ISP-FE circuitry 6 may slow the drain of battery unit 31 and release bandwidth resources of system bus architecture 32 to other hardware components of mobile computing device 2, while not diminishing the ZSL support provided by mobile computing device 2.

As such, FIG. 1B illustrates a system configuration of this disclosure according to which ISP-FE circuitry 6 may leverage existing hardware infrastructure to reduce power drain on battery unit 31 while maintaining support for ZSL technology. Again, second memory device 11 consumes greater power than first memory device 8, due to the use of system bus architecture 32 to access second memory device 11, and for other reasons as well. Because first memory device 8 represents an L3 cache of mobile computing device 2, the system configuration of FIG. 1B does not require the addition of any hardware to accommodate snapshot buffer 10. Instead, the system configuration of FIG. 1B leverages existing L3 cache memory (represented by first memory device 8 in FIG. 1B), within which to implement snapshot buffer 10. In this way, according to the system configuration of this disclosure illustrated in FIG. 1B, ISP-FE circuitry 6 conserves finite energy supplied by battery unit 31, releases a portion of finite bandwidth provided by system bus architecture 32, and more evenly distributes flash cell wear between first memory device 8 and second memory device 11, while maintaining ZSL support and using hardware architecture provided by existing ZSL-enabled cameras and camera-inclusive integrated devices.

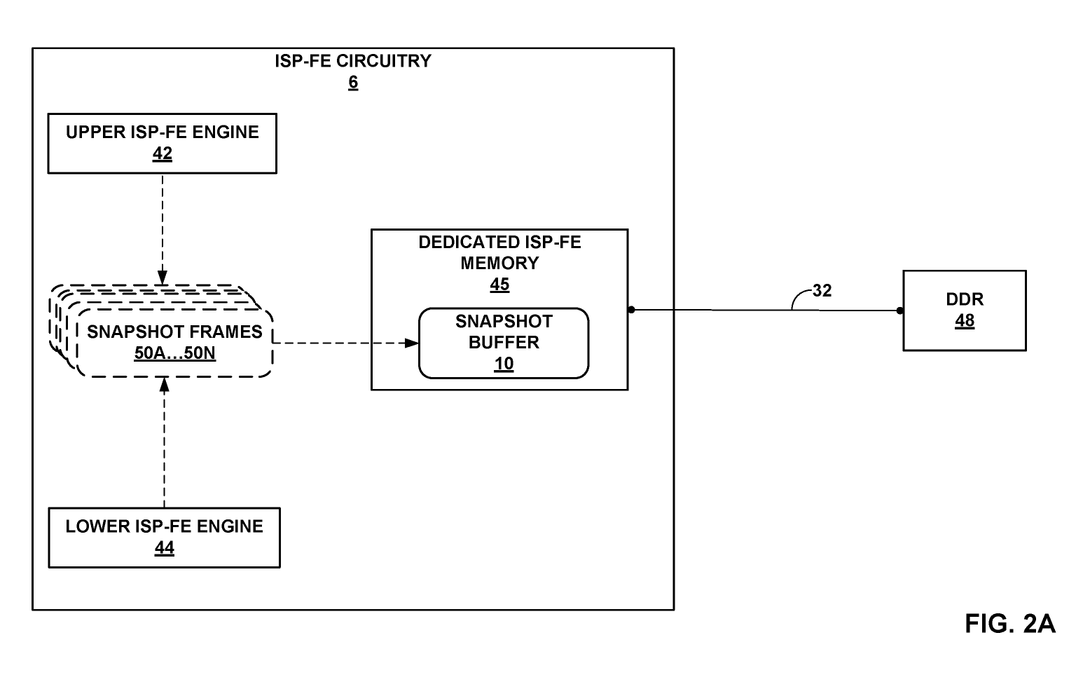

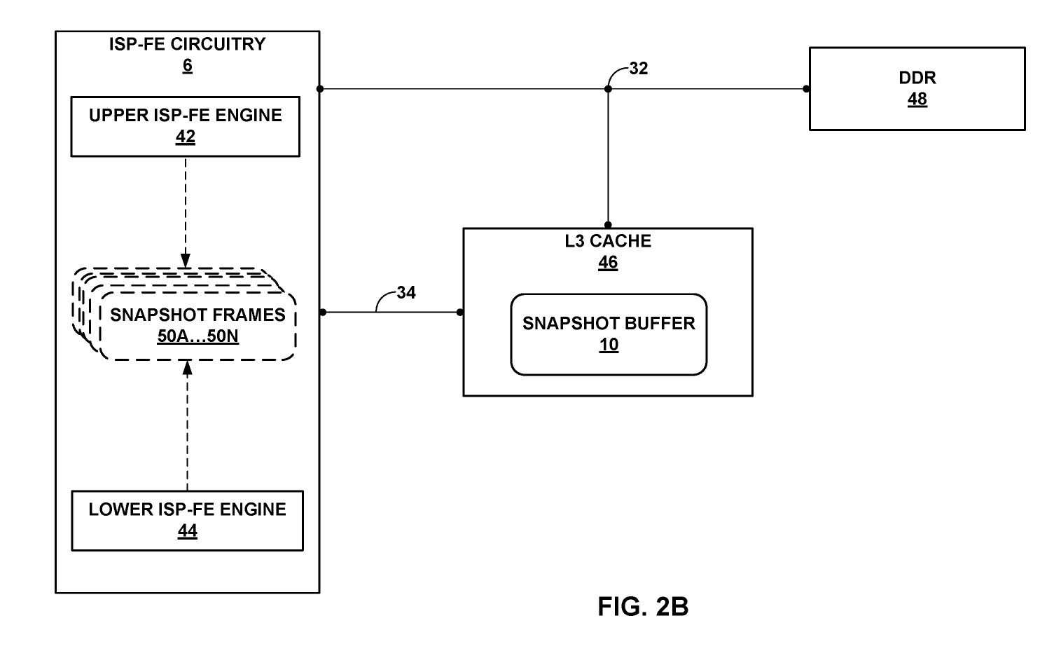

FIG. 2A is a block diagram illustrating aspects of an example implementation of the system configuration of this disclosure illustrated in FIG. 1A. In the implementation illustrated in FIG. 2A, ISP-FE circuitry 6 includes two components configured to perform front-end filtering. The two front-end filtering components of ISP-FE circuitry 6 shown in FIG. 2A are upper ISP-FE engine 42, and lower ISP-FE engine 44. Each of upper ISP-FE engine 42 and lower ISP-FE engine 44 may be formed in one or more of application specific integrated circuits (ASICs), field programmable gate arrays (FPGAs), digital signal processors (DSPs), processing circuitry (including fixed function circuitry and/or programmable processing circuitry), or other equivalent integrated circuitry or discrete logic circuitry. ISP-FE circuitry 6 may invoke upper ISP-FE engine 42, and lower ISP-FE engine 44 to perform, in parallel, front-end filtering operations with respect to a frame received from camera hardware 4. As used herein, the “parallel” performance of front-end filtering refers to the performance of analogous front-end filtering operations on different portions of the same frame received from camera hardware 4. It will be appreciated that “parallel” performance includes scenarios in which the front-end operations occur simultaneously, with some time overlap but not entirely simultaneously, or with no time overlap at all.

For instance, upper ISP-FE engine 42 may perform the front-end filtering operations (as described above with respect to FIG. 1, referring to ISP-FE circuitry 6) for an upper portion of a frame received from camera hardware 4. Similarly, lower ISP-FE engine 44 may perform the above-described front-end filtering operations with respect to a lower portion of the same frame. In one example, ISP-FE circuitry 6 may resolve a received frame into a total of two-hundred (200) horizontal lines. In this example, upper ISP-FE engine 42 may apply front-end filtering to the top hundred (100) lines of the received frame, and lower ISP-FE engine 44 may apply front-end filtering to the bottom hundred (100) lines of the same received frame.

Once upper ISP-FE engine 42 and lower ISP-FE engine 44 complete their respective front-end filtering operations with respect to a particular frame received from camera hardware 4, ISP-FE circuitry 6 may determine that the front-end filtered frame is in condition to be buffered as a snapshot frame. Frames that have been fully front-end filtered by upper ISP-FE engine 42 and lower ISP-FE engine 44 are illustrated in FIG. 2A as snapshot frames 50A-50N (collectively, “snapshot frames 50”).

In the example of FIG. 2A, snapshot buffer 10 is implemented in dedicated ISP-FE memory 45. Dedicated ISP-FE memory 45 is one non-limiting example of first memory device 8, in accordance with the system configuration of this disclosure illustrated in FIG. 1A. That is, dedicated ISP-FE memory 45 represents one or more memory devices that are included within ISP-FE circuitry 6, in accordance with the system configuration of this disclosure illustrated in FIG. 1A. Double data rate memory (DDR 48) is one non-limiting example of second memory device 11 illustrated in FIG. 1.

As described above with respect to FIG. 1A, ISP-FE circuitry 6 may implement the techniques of this disclosure to use internal communication infrastructure to continually store snapshot frames 50 to snapshot buffer 10 of dedicated ISP-FE memory 45. For instance, ISP-FE circuitry 6 may implement erase-and-write operations with respect to snapshot buffer 10, to maintain the five most recent frames of snapshot frames 50 in snapshot buffer 10. In accordance with the techniques of this disclosure, may use system bus architecture 32 to push one of snapshot frames 50 to DDR 48, in response to user input processing circuitry 24 detecting and processing a capture command. By reserving the pushing of a snapshot frame 50 from dedicated ISP-FE memory 45 to DDR 48 for the occasion of receiving a user capture command, ISP-FE circuitry 6 may reduce the power and computing resource consumption associated with circular snapshot buffering. According to some aspects of this disclosure, ISP-FE circuitry 6 may implement a modified DDR voting scheme that conserves bandwidth available over system bus architecture 32 and DDR 48.

DDR 48 and system bus architecture 32 may be configured to operate at different frequencies, based on access requests received from various components or “cores” of mobile computing device 2. For instance, if accessing DDR 48 according to traditional snapshot buffering technology, ISP-FE circuitry 6 may submit one or more DDR votes, to gain access to DDR 45 for erase-and-write operations. According to traditional ZSL snapshot buffering technology, ISP-FE circuitry 6 would submit DDR votes at all times that a camera app is active and running on mobile computing device 2. For instance, according to traditional ZSL-supporting snapshot buffering, ISP-FE circuitry 6 would begin implementing a DDR-voting scheme upon the camera app being invoked, and would not cease implementing the DDR-voting scheme until the camera app is shut down. Due to the continuous incoming DDR votes from ISP-FE circuitry 6 while the camera app is active, DDR 45 and system bus architecture 32 may run at a high frequency for the entire duration of time that the camera app is active. Thus, DDR 45 and system bus architecture 32 may tax power and computing resources of mobile computing device 2 significantly for the entire time that a camera app is active, according to traditional ZSL-supporting snapshot buffering techniques.

Based on instructions received from an ISP kernel driver executing on CPU 18, ISP-FE circuitry 6 may implement techniques of this disclosure to reduce DDR voting to apply to only a portion of the time that the camera app is actively running on mobile computing device 2. Namely, ISP-FE circuitry 6 may not commence the DDR-voting scheme purely in response to the activation of the camera app. Instead, according to aspects of this disclosure, ISP-FE circuitry 6 may begin implementing the DDR-voting scheme upon detecting a user-submitted capture command. That is, ISP-FE circuitry 6 may implement the modified DDR-voting techniques of this disclosure to limit the generation of DDR votes to scenarios in which ISP-FE circuitry 6 is attempting to push a snapshot frame from dedicated ISP-FE memory 45 to DDR 48.

By limiting the generation and submission of DDR votes to scenarios in which ISP-FE circuitry 6 is attempting to push a snapshot frame to DDR 48, ISP-FE circuitry 6 may reduce the duration of time that DDR 48 and system bus architecture 32 operate at high frequency, regardless of the length of time that the camera app is active. Said another way, ISP-FE circuitry 6 may allow DDR 48 and system bus architecture 32 to operate at a low frequency for a greater portion of the length of time that the camera app is active on mobile computing device 2. By reducing the high frequency operation time of DDR 48 and system bus architecture 32, ISP-FE circuitry 6 may use the modified DDR-voting scheme of this disclosure to mitigate power consumption caused by snapshot buffering to support ZSL.

In various implementations of this disclosure, dedicated ISP-FE memory 45 may have a storage capacity of one hundred megabytes (100 MB), or even less. For instance, the file size of a thirteen megapixel (13MP) snapshot frame may be approximately fourteen megabytes (14 MB), in accordance with the Bayer Pixel Format. As such, the 100 MB (or less) storage capacity of dedicated ISP-FE memory 45 is sufficient to store at least five snapshot frames, in fulfillment of ZSL support.

Moreover, the configurations of DDR 48 and system bus architecture 32 are agnostic to any modifications to DDR voting implemented by ISP-FE circuitry 6. Therefore, ISP-FE circuitry 6 may implement the modified DDR-voting scheme of this disclosure without necessitating any hardware infrastructure modifications with respect to either DDR 48 or system bus architecture 32. In this manner, ISP-FE circuitry 6 may implement the modified DDR-voting scheme of this disclosure to reduce power and computing resource consumption by DDR 48 and system bus architecture 32, while maintaining support for ZSL technology and leveraging existing hardware infrastructure of DDR 48 and system bus architecture 32.

FIG. 2B is a block diagram illustrating aspects of an example implementation of the system configuration of this disclosure illustrated in FIG. 1B. In the implementation illustrated in FIG. 2B, ISP-FE circuitry 6 includes the two components configured to perform front-end filtering as illustrated in FIG. 2A, namely, upper ISP-FE engine 42, and lower ISP-FE engine 44. As described with respect to FIG. 2A, each of upper ISP-FE engine 42 and lower ISP-FE engine 44 may be formed in one or more of application specific integrated circuits (ASICs), field programmable gate arrays (FPGAs), digital signal processors (DSPs), processing circuitry (including fixed function circuitry and/or programmable processing circuitry), or other equivalent integrated circuitry or discrete logic circuitry. Again, it will be appreciated that upper ISP-FE engine 42 and lower ISP-FE engine 44 may share and/or parallelize front-end filtering operations in a number of ways. However, this disclosure uses, as a non-limiting example, a scheme by which upper ISP-FE engine 42 may apply front-end filtering to the top hundred (100) lines of a frame received from camera hardware 4, and lower ISP-FE engine 44 may apply front-end filtering to the bottom hundred (100) lines of the same received frame.

In the example of FIG. 2B, snapshot buffer 10 is implemented in a level 3 (L3) cache 46 of mobile computing device 2. L3 cache 46 is one non-limiting example of first memory device 8, in accordance with the system configuration of this disclosure illustrated in FIG. 1B. In some examples, L3 cache 46 represents a last level cache (LLC) of mobile computing device 2. In other examples, mobile computing device 2 may implement greater levels of cache memory than level 3, such that L3 cache 46 does not represent an LLC of mobile computing device 2. Double data rate memory (DDR 48) is one non-limiting example of second memory device 11 illustrated in FIG. 1.

As described above with respect to FIG. 1, ISP-FE circuitry 6 may implement the techniques of this disclosure to use OCM bus 34 to continually store snapshot frames 50 to snapshot buffer 10. In example use cases described herein, ISP-FE circuitry 6 may implement erase-and-write operations with respect to snapshot buffer 10, to maintain the five most recent frames of snapshot frames 50 in snapshot buffer 10. In accordance with the techniques of this disclosure, ISP-FE circuitry 6 may use system bus architecture 32 to push one of snapshot frames 50 to DDR 48, in response to user input processing circuitry 24 detecting and processing a capture command.

As described above, DDR 48 and system bus architecture 32 may be configured to operate at a more power-intensive “high frequency” in response to DDR 48 receiving access-requesting “votes” from various cores of mobile computing device 2. ISP-FE circuitry 6 may also implement modified DDR-voting schemes of this disclosure to conserve resources in the system configuration illustrated in FIG. 2B. For instance, ISP-FE circuitry 6 may mitigate the drain of battery unit 31 that would be caused by the DDR-voting aspects of tradition ZSL-supporting snapshot buffering technology. Again, according to traditional ZSL snapshot buffering technology, ISP-FE circuitry 6 would submit DDR votes at all times that a camera app is active and running on mobile computing device 2. Due to the continuous incoming DDR votes from ISP-FE circuitry 6 while the camera app is active, DDR 45 and system bus architecture 32 may run at a high frequency for the entire duration of time that the camera app is active, thereby imposing greater power-draw burdens on battery unit 31.

According to the modified DDR-voting scheme of this disclosure, ISP-FE circuitry 6 may reduce DDR vote submission to only a portion of the time that the camera app is actively running on mobile computing device 2. Namely, ISP-FE circuitry 6 may not commence the DDR-voting scheme purely in response to the activation of the camera app. Instead, according to aspects of this disclosure, ISP-FE circuitry 6 may begin implementing the DDR-voting scheme upon detecting a user-submitted capture command. That is, ISP-FE circuitry 6 may implement the modified DDR-voting techniques of this disclosure to limit the generation of DDR votes to scenarios in which ISP-FE circuitry 6 is attempting to push a snapshot frame from dedicated ISP-FE memory 45 to DDR 45.

By limiting the generation and submission of DDR votes to scenarios in which ISP-FE circuitry 6 is attempting to push a snapshot frame from L3 cache 46 to DDR 48 over system bus architecture 32, ISP-FE circuitry 6 may reduce the duration of time that DDR 48 and system bus architecture 32 operate at high frequency, regardless of the length of time that the camera app is active. Said another way, ISP-FE circuitry 6 may allow DDR 48 and system bus architecture 32 to operate at a low frequency for a greater portion of the length of time that the camera app is active on mobile computing device 2. By reducing the high frequency operation time of DDR 48 and system bus architecture 32, ISP-FE circuitry 6 may use the modified DDR-voting scheme of this disclosure to slow the drain of battery unit 31 caused by snapshot buffering to support ZSL. For instance, ISP-FE circuitry 6 may leverage the more power-efficient access to L3 cache 46 over OCM bus 34 at all times that the camera app is active, but a user-provided capture command has not been received via user input processing circuitry 24.

Moreover, the configurations of DDR 48, system bus architecture 32, L3 cache 46, and OCM bus 34 are agnostic to any modifications to DDR voting implemented by ISP-FE circuitry 6. Therefore, ISP-FE circuitry 6 may implement the modified DDR-voting scheme of this disclosure without necessitating any hardware infrastructure modifications with respect to any of DDR 48, system bus architecture 32, L3 cache 46, or OCM bus 34. In this manner, ISP-FE circuitry 6 may implement the modified DDR-voting scheme of this disclosure to slow the drain of battery unit 31 by DDR 48 and system bus architecture 32, while maintaining support for ZSL technology and leveraging existing hardware infrastructure of DDR 48, system bus architecture 32, L3 cache 46, and OCM bus 34.

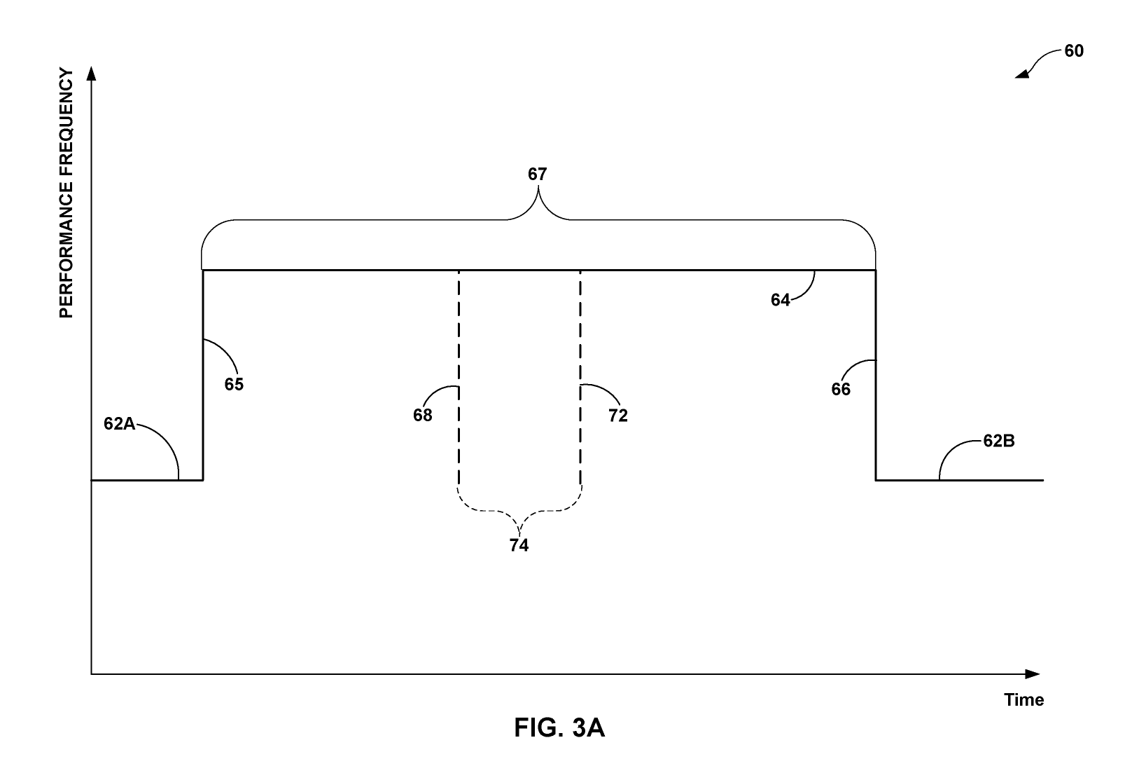

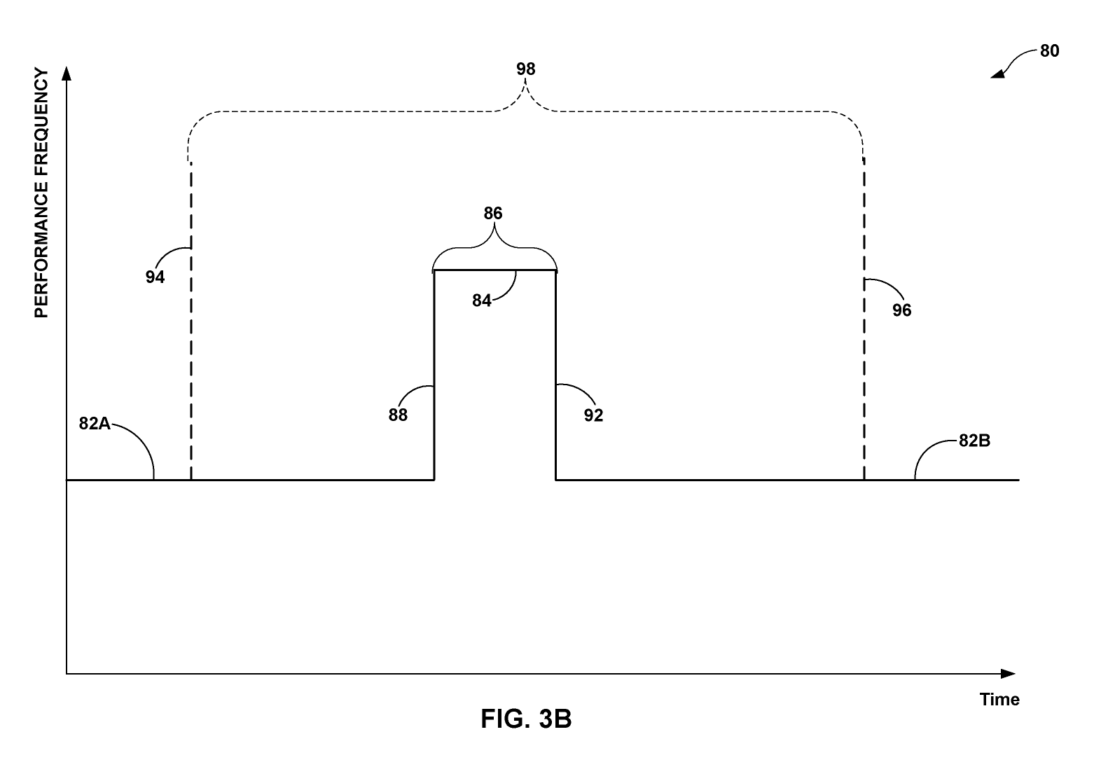

FIG. 3A illustrates a timing diagram 60 that shows performance frequency changes of DDR 48 and system bus architecture 32 as affected by DDR-voting aspects of traditional snapshot buffering techniques to support ZSL. For ease of illustration, FIG. 3A includes a single line to plot the performance frequency of both DDR 48 and system bus architecture 32. It will be understood that in practice, however, the performance frequencies of DDR 48 and system bus architecture 32 need not be the same, and need not vary in exact synchrony. Moreover, while timing diagram 60 shows the performance frequency changes of DDR 48 and system bus architecture 32 as a two-state toggling operation, in some instances, a greater number of performance frequencies than two may be supported by DDR 48 and/or by system bus architecture 32. In some such instances, changes in performance frequency may be expressed as a more gradual (or “smoother”) transition than the toggle operation illustrated in FIG. 3A. Moreover, for ease of illustration and discussion, timing diagram 60 represents changes in performance frequency of DDR 48 and system bus architecture 32 as caused by DDR-voting by ISP-FE circuitry, without reflecting the frequency-altering effects of DDR-voting implemented by other cores/components of mobile computing device 2.

The horizontal axis (x-axis) of timing diagram 60 plots the progression of time, and the vertical axis (y-axis) of timing diagram 60 plots the performance frequency of DDR 48 and system bus architecture 32, as affected by ISP-FE circuitry 6. In the example of FIG. 3A, DDR 48 and system bus architecture 32, at any given time, operate in one of two possible frequency states, each of which corresponds to a particular y-coordinate or “height” vis-à-vis the y-axis of timing diagram 60. During a time when a camera app is not actively running on mobile computing device 2, ISP-FE circuitry 6 may not submit DDR votes for snapshot frame buffering. The lack of DDR votes from ISP-FE circuitry 6 may enable DDR 48 and system bus architecture 32 to operate at a lower performance frequency 62 (which is shown in two separate time intervals 62A and 62B in timing diagram 60).

In contrast, while the camera app is active and running on mobile computing device 2, DDR 48 and system bus architecture 32 may operate at a higher performance frequency 64. The x-coordinate of a camera app activation event 65 as plotted in timing diagram 60 indicates the timing of the camera app being invoked on mobile computing device 2. Similarly, the x-coordinate of a camera app deactivation event 66 as plotted in timing diagram 60 indicates the timing of the camera app being shut down or moved to an operation background on mobile computing device 2. For instance, the x-coordinate of camera app activation event 65 may approximately correspond to a time at which a user provides tactile input via a touchscreen of mobile computing device 2, to invoke the camera app. Similarly, the x-coordinate of camera app deactivation event 66 may approximately correspond to a time at which a user provides tactile input via the touchscreen of mobile computing device 2, to shut the camera app down, or to move the camera app to background operation.

Camera app activation event 65 and camera app deactivation event 66, respectively, represent the beginning and end times of the camera app actively running on mobile computing device 2. As shown in timing diagram 60, according to traditional DDR-voting schemes to implement snapshot frame buffering for ZSL support, ISP-FE circuitry 6 controls DDR 48 and system bus architecture 32 operate at high performance frequency 64 for the entire duration of time that the camera app is active on mobile computing device 2. The length of time for which ISP-FE circuitry 6 controls DDR 48 and system bus architecture 32 to operate at high performance frequency 64 in this scenario is denoted by high-frequency time interval 67.

Timing diagram 60 also illustrates two other actions that ISP-FE circuitry 6 may perform in accordance with ZSL-supported image capture functionalities. That is, timing diagram 60 illustrates the occurrence times of capture command detection 68 and snapshot frame extraction 72. The x-coordinate of capture command detection 68 may correspond to the time at which ISP-FE circuitry 6 receives an indication of a user-provided capture command from user input processing circuitry 24. The x-coordinate of snapshot frame extraction 72 may correspond to the time at which ISP-FE circuitry 6 selects and reads a snapshot frame from a DDR-implemented buffer for further processing, in accordance with traditional ZSL-supporting image capture technology. The time elapsed between capture command detection 68 and snapshot frame extraction 72 is denoted in timing diagram 60 as image capture response time interval 74. The time elapsed between capture command detection 68 and snapshot frame extraction 72 may also be described between “trigger detection” and “frame transfer.” That is, “trigger detection” may represent the detection of a capture command, and “frame transfer” may represent the extraction and the commencement of further filtering (e.g., performed by ISP-PP circuitry 12) of a selected snapshot frame.

While FIG. 3A is not necessarily drawn to scale, it will be appreciated that image capture response time interval 74 forms a portion, but does not span the entirety, of high-frequency time interval 67. By implementing various techniques of this disclosure, ISP-FE circuitry 6 may reduce high-frequency time interval 67 to be closer to, or possibly equal to, the time duration reflected by image capture response time interval 74. Aspects of the techniques of this disclosure that ISP-FE circuitry 6 may perform to reduce the duration of high-frequency time interval 74 are described below, with respect to FIG. 3B.

FIG. 3B illustrates a timing diagram 80 that shows performance frequency changes of DDR 48 and system bus architecture 32 as affected by the modified DDR-voting aspects of this disclosure that ISP-FE circuitry 6 may perform to reduce resource consumption while maintaining ZSL support. In the example of timing diagram 80, the combination of low frequency intervals 82A and 82B make up the time that DDR 48 and system bus architecture 32 operate at low performance frequency 82, within the total time denoted in FIG. 3B. DDR 48 and system bus architecture 32 operate at high performance frequency 84 for a length of time denoted by high-frequency interval 86, in the scenario illustrated in FIG. 3B. FIG. 3B also illustrates capture command detection 88, snapshot frame push event 92, camera activation event 94, and camera deactivation event 96.

ISP-FE circuitry 6 may implement the modified DDR-voting techniques of this disclosure to begin submitting DDR votes upon detection of a user-provided capture command via user input processing circuitry 24. That is, ISP-FE circuitry 6 may begin submitting DDR votes at or approximately at the time of capture command detection 88. That is, in contrast to traditional ZSL-supporting DDR-voting technology, ISP-FE circuitry 6 may implement the techniques of this disclosure to postpone or delay the triggering of DDR vote submission. As such, ISP-FE circuitry 6 may delay the occurrence of the stimulus that controls DDR 48 and system bus architecture 32 to transition from operating at low performance frequency 82 to operating at high performance frequency 84. The delay is illustrated in FIG. 3B in that timing diagram 80 shows an upward toggle of performance frequency occurring subsequently to the time of camera app activation 94, at the time of capture command detection 88. In this way, ISP-FE circuitry 6 permits DDR 48 and system bus architecture 32 to continue operating at low performance frequency 82 (shown by the prolonging of low frequency interval 82A) after the time of camera app activation event 94.

In response to capture command detection 88, ISP-FE circuitry 6 may select a snapshot frame from snapshot buffer 10, and push the selected snapshot frame from first memory device 8 to DDR 48. It will be appreciated that ISP-FE circuitry 6 may push the selected snapshot from first memory device 8 to DDR 48 in response to capture command detection 88, in both of the system configurations illustrated in FIGS. 1A and 1B. On timing diagram 80, the operation implemented by ISP-FE circuitry 6 to push the selected snapshot frame from first memory device 8 to DDR 48 is denoted by snapshot frame push event 92.

Upon pushing the selected snapshot frame from first memory device 8 to DDR 48, ISP-FE circuitry 6 may cease submitting DDR votes. That is, in comparison to traditional DDR-voting schemes implemented for snapshot buffering to support ZSL, ISP-FE circuitry 6 may advance the cessation of DDR vote submission. The advancement is illustrated in FIG. 3B in that timing diagram 80 shows a downward toggle of performance frequency occurring prior to the time of camera app deactivation event 96. In this way, ISP-FE circuitry 6 permits DDR 48 and system bus architecture 32 to return to operating at low performance frequency 82 (shown by the earlier beginning of low frequency interval 82B) prior to the time of camera app deactivation event 96.

FIG. 3B illustrates the reduction of high-frequency operation time of DDR 48 and system bus architecture 32 yielded by the techniques of this disclosure implemented by ISP-FE circuitry 6. For instance, according to traditional DDR-voting techniques to implement snapshot frame buffering to support ZSL, DDR 48 and system bus architecture 32 would operate at high performance frequency 84 for a duration of time denoted in FIG. 3B by active camera interval 98. Active camera interval 98 spans a length of time from camera app activation event 94 until camera app deactivation event 96. However, by implementing the modified snapshot buffering and modified DDR-voting techniques of this disclosure, ISP-FE circuitry 6 may reduce the time duration of high-frequency operation of DDR 48 and system bus architecture 32. The reduction is shown in FIG. 3B in that high-frequency operation interval 86 is shorter than active camera interval 98.

By reducing the length of time that DDR 48 and system bus architecture 32 are operate at high performance frequency 84, ISP-FE circuitry 6 implements the techniques of this disclosure to reduce resource consumption, while maintaining ZSL support. As discussed above, high performance frequency 84 represents a more power-intensive operation mode of DDR 48 and system bus architecture 32, when compared to low performance frequency 82. By reducing the power-intensive high-frequency operation time length of DDR 48 and system bus architecture 32 from active camera interval 98 down to high-frequency interval 86, ISP-FE circuitry 6 reduces the power drain on battery unit 31. That is, ISP-FE circuitry 6 may implement the techniques of this disclosure to prolong the life of battery unit 31, while maintaining support for ZSL camera technology.

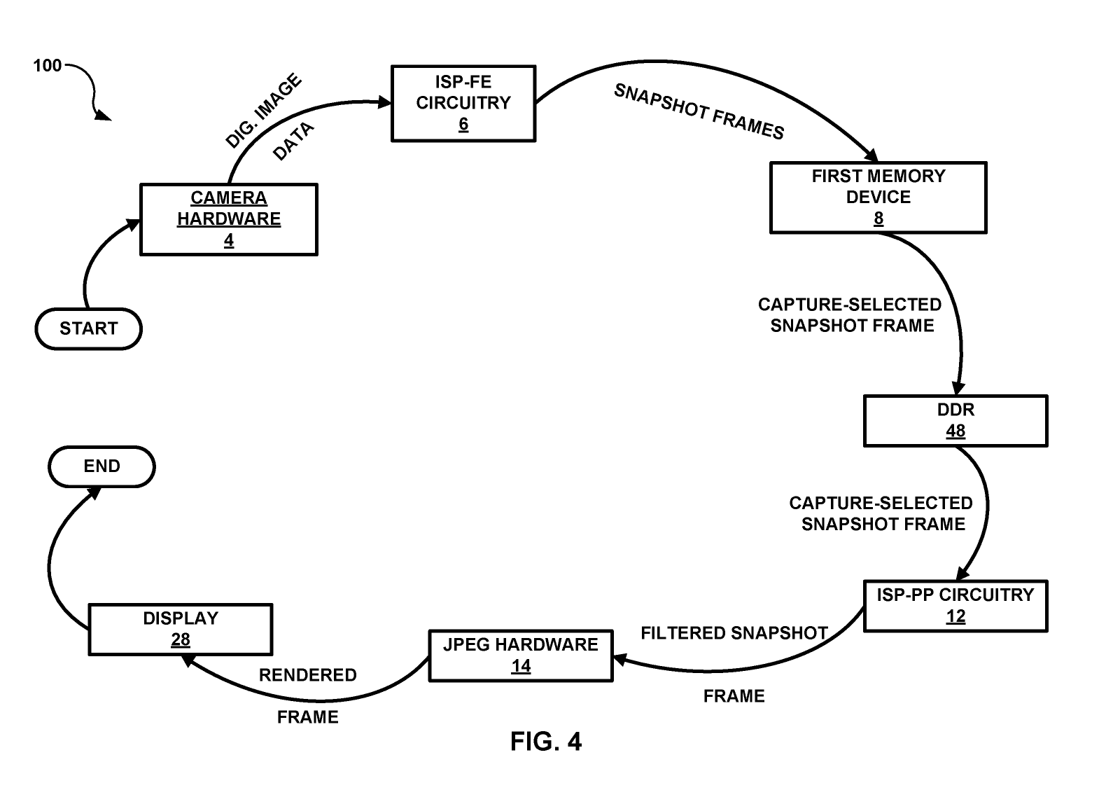

FIG. 4 is a data flow diagram (DFD) 100 illustrating an example of interactive operation of various hardware components of mobile computing device 2 according to aspects of this disclosure. DFD 100 is described herein with respect to the snapshot stream implemented by mobile computing device 2, although certain aspects of DFD 100 may also apply to the preview stream. It will be appreciated that DFD 100 is not intended to represent the entirety of snapshot stream processing by the cores of mobile computing device 2, and that mobile computing device 2 may implement additional functionalities with respect to the snapshot stream.

At the start of DFD 100, camera hardware 4 may implement photosensing capabilities to detect raw image data, or may otherwise have access to the raw image data. Again, camera hardware 4 may include, be, or be part of various lens-sensor hardware combinations. As long as a camera or video app is actively running on mobile computing device 2, camera hardware 4 may sense multiple frames of image data according to a frame rate being implemented by mobile computing device 2.

In turn, camera hardware 4 may provide digital image data (representing the frames) to ISP-FE circuitry 6. ISP-FE circuitry 6 may perform processing (e.g., front-end filtering) of the frames received from camera hardware 4. By implementing the front-end filtering on the received frames, ISP-FE circuitry 6 may condition the frames for potential user-initiated capture as a digital photograph. Through the front-end filtering operations, ISP-FE circuitry 6 may maintain the full resolution of the frames received from camera hardware 4. Full resolution, front-end filtered frames processed in this manner by ISP-FE circuitry 6 are referred to as “snapshot frames.”

Implementing the techniques of this disclosure, ISP-FE circuitry 6 may continually buffer the snapshot frames to first memory device 8. For instance, ISP-FE circuitry 6 may continually store the 5 most recently received and filtered frames, at full resolution, to snapshot buffer 10. According to various aspects of this disclosure, snapshot buffer 10 is implemented in first memory device 8. In some system configurations of this disclosure (e.g., as shown in FIG. 1A), first memory device 8 represents a dedicated memory implemented within ISP-FE circuitry 6. For instance, in one such system configuration, first memory device 8 may include, be, or be part of dedicated ISP-FE memory 45 shown in FIG. 2A. In these system configurations, ISP-FE circuitry 6 may perform the circular buffering of the five most recently processed snapshot frames by using internal communications infrastructure. In other system configurations of this disclosure (e.g., as shown in FIG. 1B), first memory device 8 represents a type of on-chip memory that is implemented externally to ISP-FE circuitry 6. For instance, in one such system configuration, first memory device 8 may include, be, or be part of L3 cache 46 shown in FIG. 2B. In these system configurations, ISP-FE circuitry 6 may perform the circular buffering of the five most recently processed snapshot frames using OCM bus 34.

During the buffering of snapshot frames to first memory device 8, ISP-FE circuitry 6 may avoid generating DDR votes, because the snapshot buffering does not, at this stage, call for the use of system bus architecture 32 or DDR 48. In the absence of DDR votes being received from ISP-FE circuitry 6, a resource power manager of mobile computing device 2 may permit system bus architecture 32 and DDR 48 to continue operating at lower performance frequency 82 of FIG. 3B. Again, low performance frequency 82 represents an operating mode in which system bus architecture 32 and DDR 48 drain battery unit 31 at a slower rate than in high performance frequency 84.

Upon detecting a user-provided capture command via user input processing circuitry 24, the ISP kernel driver running on CPU 18 may identify one of the snapshot frames 50 buffered in first memory device 8 as a capture-selected snapshot frame for ISP-FE circuitry 6 to extract for further processing. That is, ISP-FE circuitry 6 may determine that the identified snapshot frame 50 is a frame that the user attempted to capture as a digital photograph. Based on identifying a buffered snapshot 50 as a capture-selected snapshot frame, ISP-FE circuitry 6 may push the capture-selected snapshot frame from first memory device 8 to DDR 48. For instance, in order to perform the write operations on DDR 48 to implement the push of the capture-selected snapshot, ISP-FE circuitry 6 may begin generating and submitting DDR votes. In turn, the resource power manager of mobile computing device 2 may control system bus architecture 32 and DDR 48 to begin functioning at high performance frequency 84. That is, in preparation to more effectively accommodate the write operations that ISP-FE circuitry 6 may perform to push the capture-selected snapshot to DDR 48, the resource power manager of mobile computing device 2 may increase the performance level of system bus architecture 32 and DDR 48.

To continue the progression of the snapshot stream as shown in DFD 100, ISP-PP circuitry 12 may extract the capture-selected snapshot frame from DDR 48 for additional filtering, to further refine the capture-selected snapshot frame. For instance, ISP-PP circuitry 12 may apply back-end filtering to the capture-selected snapshot frame extracted from DDR 48. By applying the back-end filtering to the capture-selected snapshot frame, ISP-PP 12 may further condition the frame for use as a digital photograph, and optionally, for statistical analysis by other cores of mobile computing device 2.

In turn, ISP-PP circuitry 12 may push the back-end filtered snapshot frame to JPEG hardware 14. JPEG hardware 14 may render the back-end filtered snapshot frame to form a frame for rendering. That is, JPEG hardware 14 may prepare the filtered and refined snapshot frame, which has been selected for capture as a digital photograph, to be rendered for viewing by a user. JPEG hardware 14 may, directly or indirectly, provide the rendered snapshot frames to display 28 for visual output.

As shown in DFD 100 and described with respect to DFD 100, the system configurations and techniques of this disclosure may enable various cores of mobile computing device 2 to synergistically achieve power savings without diminishing user experience or data accuracy. For instance, the implementation of snapshot buffer 10 in first memory device 8 enables ISP-FE circuitry 6 to perform a portion of the ZSL-related write operations over less power-intensive resources, such as OCM bus 34 or internal communications infrastructure included within ISP-FE circuitry 6. Moreover, ISP-FE circuitry may implement the modified DDR-voting scheme of this disclosure to delay the beginning of generation of DDR votes until receipt of a capture command. The modified DDR-voting scheme of this disclosure may also enable ISP-FE circuitry 6 to cease the generation of DDR votes at an earlier time than according to traditional ZSL technology, by ceasing generating the DDR votes upon completion of the push of a capture-selected snapshot frame to DDR 48. The delayed beginning and advanced cessation of DDR vote generation enables ISP-FE circuitry 6 to prolong the life of battery unit 31, by reducing the total time that DDR 48 and system bus architecture 32 operate at high performance frequency 84.

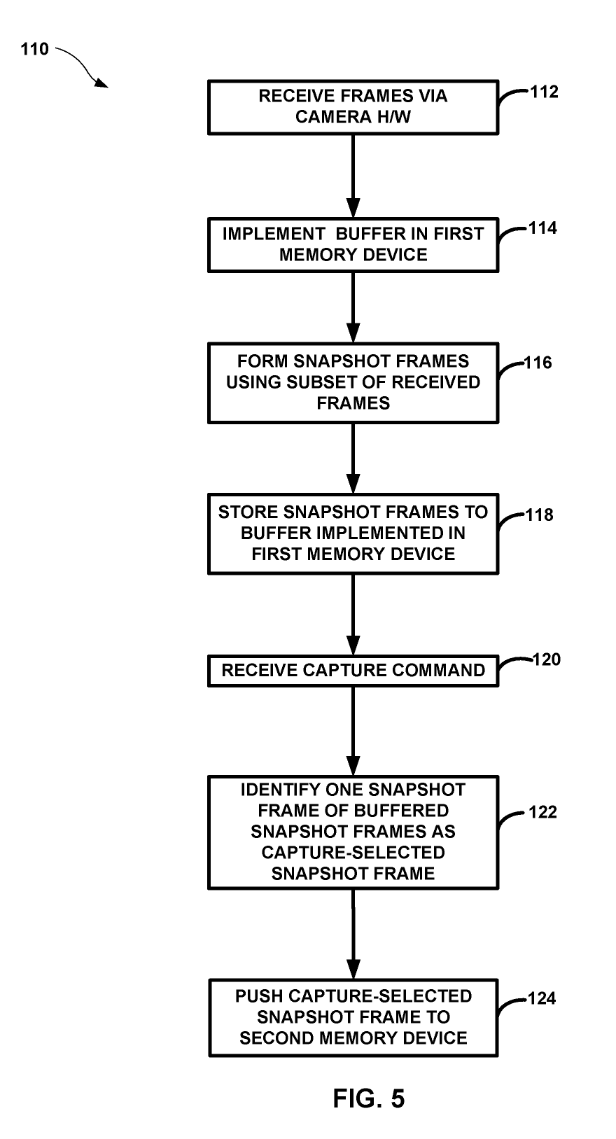

FIG. 5 is a flowchart illustrating an example process 110 by which mobile computing device 2 may implement the snapshot buffering technologies of this disclosure to mitigate power drain on battery unit while supporting the user experience provided by ZSL. Process 110 may begin when mobile computing device 2 receives, via camera hardware 4, multiple frames for a camera application executing on mobile computing device 2 (112). For instance, photo-detecting hardware of camera hardware 4 may sense image data for a stream of pictures to support still photograph and/or video capture capabilities of mobile computing device 2. Mobile computing device 2 may implement snapshot buffer 10 in first memory device 8 (114). For example, mobile computing device may initialize or instantiate the snapshot buffer using the hardware capabilities provided by first memory device 8. According to various system configurations of this disclosure, first memory device 8 may be included within ISP-FE circuitry 6 (e.g., in the form of dedicated ISP-FE memory 45 shown in FIG. 2A), or may be included in an on-chip memory device that is external to ISP-FE circuitry 6 (e.g., in the form of L3 cache 46 shown in FIG. 2B). In various implementations of this disclosure, dedicated ISP-FE memory 45 may have a storage capacity of one hundred megabytes (100 MB), or even less.

ISP-FE circuitry 6 may form snapshot frames using a subset of the frames received via camera hardware 4 (116). For instance, ISP-FE circuitry 6 may apply one or more filtering operations to sharpen the received frames, such as automatic varifocal filtering (AVF), pixelwise dark channel prior (PDCP) filters, and other filters. ISP-FE circuitry 6 may also implement noise reduction or noise removal, de-mosaicing, black level correction, pixel correction (e.g., to identify faulty pixels and then predict the faulty pixels from neighboring pixels), and/or color conversion. ISP-FE circuitry 6 may maintain full or near-full resolution of the received frames with respect to the snapshot frames formed using the filtering operations described above. For instance, if camera hardware 4 forms frames that each has a thirteen megapixel (13MP) resolution, then ISP-FE circuitry 6 may apply the filtering operations to generate corresponding snapshot frames that has a 13MP resolution, as well. In various examples, the file size of a 13MP snapshot may be approximately fourteen megabytes (14 MB), in accordance with the Bayer Pixel Format. As such, the 100 MB (or less) storage capacity of dedicated ISP-FE memory 45 is sufficient to store at least five snapshot frames, in fulfillment of ZSL support.

ISP-FE circuitry 6 may store the snapshot frames to snapshot buffer 10, which is implemented in first memory device 8 (118). As discussed above, ISP-FE circuitry 6 may continually store the five most-recently formed snapshot frames, in a FIFO order, to snapshot buffer 10 implemented in first memory device 8. As such, snapshot buffer 10 represents a “circular” buffer, in that snapshot buffer 10 maintains the most-recently generated snapshot frames while a camera app is actively running on mobile computing device 2.

User input processing circuitry 24 may receive a capture command (120). For instance, user input processing circuitry 24 may receive the capture command by way of one or more input devices or combined input-output (I/O) devices integrated into or coupled with mobile computing device 2. Examples of capture command inputs include a tap or press gesture detected at display 28 (in examples where display 28 represents an I/O device such as a touchscreen), or an actuation of a physical button of mobile computing device 2. In response to the received capture command, ISP-FE circuitry 6 may identify one snapshot frame of the buffered snapshot frames as a capture-selected snapshot frame (122). That is, ISP-FE circuitry 6 may select, for capture as a digital photograph, a particular snapshot frame from multiples snapshot frames currently stored to snapshot buffer 10 implemented in first memory device 8. In response to the received capture command, ISP-FE circuitry 6 may push the capture-selected snapshot frame to second memory device 11 (124). For instance, ISP-FE circuitry 6 may use system bus architecture 32 to write the capture-selected snapshot frame to DDR 48, which is an example of second memory device 11.

The steps of process 110 are illustrated and described in a certain sequence purely as an example. It will be appreciated that mobile computing device 2 and/or components thereof may perform various steps of process 110 in various orders/sequences, in accordance with aspects of this disclosure. As one example, mobile computing device 2 may perform step 114 after step 112 (as shown in FIG. 5), prior to step 112, or wholly or partially concurrently with step 112. At certain portions of this disclosure the identification of the capture-selected snapshot frame from snapshot buffer 10 is described as being a selection of a “first” snapshot frame from the currently-buffered set of snapshot frames. It will be understood that the identification of a “first” snapshot frame is not meant to connote a chronology or storage location of the identified snapshot frame in comparison to other snapshot frames, but instead, is only meant to distinguish the identified snapshot frame from other snapshot frames.

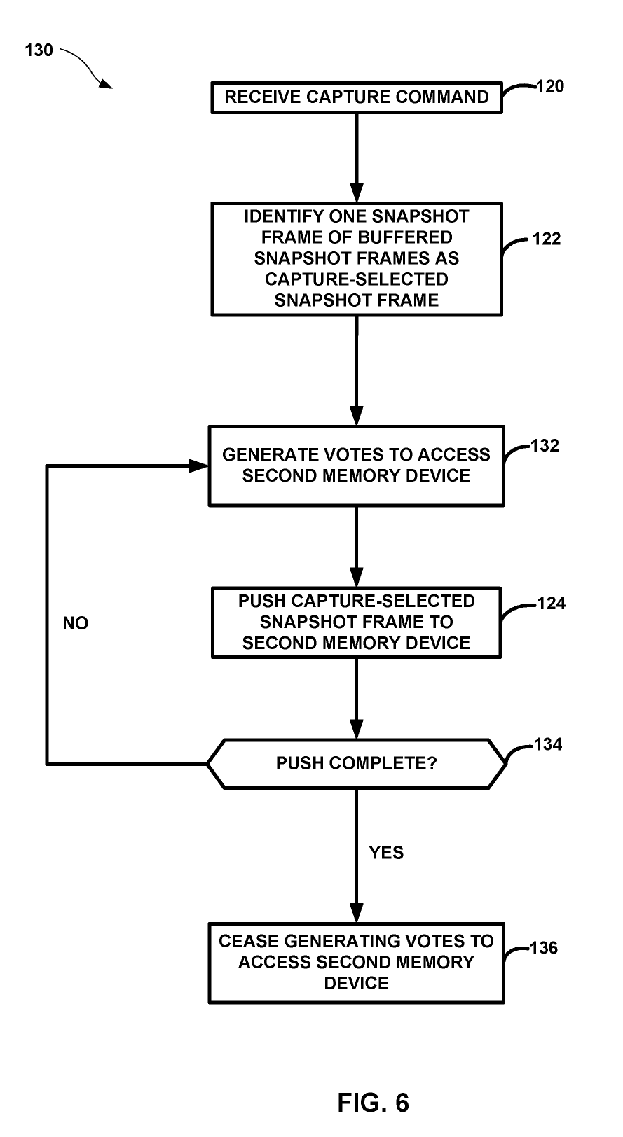

FIG. 6 is a flowchart illustrating an example process 130 by which mobile computing device 2 may implement modified DDR-voting schemes of this disclosure to mitigate power drain on battery unit while supporting the user experience provided by ZSL. Process 130 includes various steps in common with process 110 of FIG. 5, and the steps that are included in both processes 110 and 130 share common reference numerals in FIGS. 5 and 6. Process 130 may begin when user input processing circuitry 24 receives a capture command (120). In response to the received capture command, ISP-FE circuitry 6 may identify one snapshot frame of the buffered snapshot frames as a capture-selected snapshot frame (122).

Also in response to the received capture command, ISP-FE circuitry 6 may generate one or more votes to access second memory device 11 (132). For instance, ISP-FE circuitry 6 may generate DDR votes to access DDR 48, as DDR 48 is an example of second memory device 11. In accordance with the modified DDR-voting schemes of this disclosure, ISP-FE circuitry 6 may begin generating the DDR votes in response to the capture command received by user input processing circuitry 24. That is, according to the modified DDR-voting schemes of this disclosure, ISP-FE circuitry 6 may avoid generating DDR votes until user input processing circuitry 24 receives the capture command, or until ISP-FE circuitry 6 has identified the capture-selected snapshot frame from the snapshot frames currently stored in snapshot buffer 10. As such, process 130 illustrates an example of this disclosure according to which ISP-FE circuitry 6 may begin generating one or more votes for accessing second memory device 11 in order to push a capture-selected snapshot frame to second memory device 11, in response to a user-provided capture command.

Also in response to the capture command received by user input processing circuitry 24, ISP-FE circuitry 6 may push the capture-selected snapshot frame to second memory device 11 (124). For instance, by generating votes to access second memory device 11 at step 132, ISP-FE circuitry 6 may control second memory device 11 and system bus architecture 32 to operate at high performance frequency 84. By operating at high performance frequency 84, second memory device 11 and system bus architecture 32 may better accommodate the write operations that ISP-FE circuitry 6 performs to push the capture-selected snapshot frame to second memory device 11. In this way, ISP-FE circuitry 6 may control second memory device 11 and system bus architecture 32 to operate at the power-intensive high performance frequency 84, in order to push the capture-selected snapshot frame from first memory device 8 to second memory device 11.

In turn, ISP-FE circuitry 6 may determine whether or not the push operation is complete (decision block 134). That is, ISP-FE circuitry 6 may determine whether or not the capture-selected snapshot has been fully written to second memory device 11. If ISP-FE circuitry 6 determines that the push of the capture-selected snapshot frame is not yet complete (NO branch of decision block 134), ISP-FE circuitry 6 may continue generating votes to access second memory device 11 (thereby returning to step 132). In response to detecting the completion of the push of the capture-selected snapshot frame to second memory device 11 (YES branch of decision block 134), ISP-FE circuitry 6 may cease generating the votes to access second memory device 11 (136). By ceasing the generation of the access votes, ISP-FE circuitry 6 may enable second memory device 11 and system bus architecture 32 to resume operating at low performance frequency 82. That is, upon detecting the completion of the push of the capture-selected snapshot frame to second memory device 11, ISP-FE circuitry 6, by ceasing the generation of access votes, may enable low-power operation of second memory device 11 and system bus architecture 32, thereby mitigating the drain of energy available from battery unit 31.

In one or more examples, the functions described may be implemented in hardware, software, firmware, or any combination thereof. If implemented in software, the functions may be stored on, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

The steps of process 130 are illustrated and described in a certain sequence purely as an example. It will be appreciated that mobile computing device 2 and/or components thereof may perform various steps of process 130 in various orders/sequences, in accordance with aspects of this disclosure.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, processing circuitry (including fixed function circuitry and/or programmable processing circuitry), application specific integrated circuits (ASICs), field programmable logic arrays (FPGAs), or other equivalent integrated circuitry or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

1. A mobile computing device having digital camera capabilities, the mobile computing device comprising:
camera hardware configured to receive a plurality of frames;
a first memory device that implements a buffer;
a second memory device that consumes greater power than the first memory device; and
processing circuitry coupled to the camera hardware, to the first memory device, and to the second memory device, the processing circuitry being configured to:
form a plurality of uncompressed snapshot frames using a subset of the plurality of the received frames;
store the plurality of uncompressed snapshot frames to the buffer implemented in the first memory device;
receive a capture command from a user input element, the capture command corresponding to user input; and
in response to receiving the capture command:
identify, as a capture-selected uncompressed snapshot frame, a first uncompressed snapshot frame of the plurality of uncompressed snapshot frames stored to the buffer implemented in the first memory device; and
push the capture-selected uncompressed snapshot frame to the second memory device that consumes greater power than the first memory device.

2. The mobile computing device of claim 1, wherein the processing circuitry is configured to:
in response to receiving the capture command, generate one or more votes, the votes being associated with accessing the second memory device to push the capture-selected uncompressed snapshot frame to the second memory device.

3. The mobile computing device of claim 2, wherein the processing circuitry is configured to:
detect a completion of the push of the capture-selected uncompressed snapshot frame to the second memory device; and
in response to the detection of the completion of the push of the capture-selected uncompressed snapshot frame to the second memory device, cease generating the one or more votes.

4. The mobile computing device of claim 2, wherein the processing circuitry is further configured to:
detect a completion of the push of the capture-selected uncompressed snapshot frame to the second memory device; and
in response to the detection of the completion of the push of the capture-selected uncompressed snapshot frame to the second memory device, control the second memory device to operate according to a low performance frequency.

5. The mobile computing device of claim 1, wherein the processing circuitry is further configured to:
in response to receiving the capture command, control the second memory device to operate according to a high performance frequency.

6. The mobile computing device of claim 1, wherein the first memory device is included within image signal processing circuitry of the mobile computing device.

7. The mobile computing device of claim 1, wherein the first memory device comprises a level 3 (L3) cache of the mobile computing device.

8. The mobile computing device of claim 7, further comprising an on-chip memory (OCM) bus that couples the processing circuitry to the first memory device.

9. The mobile computing device of claim 1, further comprising a system bus that couples the processing circuitry to the second memory device.

10. A method comprising:
receiving, by camera hardware of a mobile computing device, a plurality of frames;
forming, by processing circuitry of the mobile computing device, a plurality of uncompressed snapshot frames using a subset of the plurality of the frames received by the camera hardware;
storing, by the processing circuitry, the plurality of uncompressed snapshot frames to a buffer implemented in a first memory device of the mobile computing device;
receiving, by the processing circuitry, a capture command from a user input element, the capture command corresponding to user input; and
in response to receiving the capture command:
identifying, as a capture-selected uncompressed snapshot frame, a first uncompressed snapshot frame of the plurality of uncompressed snapshot frames stored to the buffer implemented in the first memory device; and
pushing, by the processing circuitry, the capture-selected uncompressed snapshot frame to a second memory device of the mobile computing device, wherein the second memory device consumes greater power than the first memory device.

11. The method of claim 10, further comprising:
in response to receiving the capture command, generating one or more votes, the votes being associated with accessing the second memory device for pushing the capture-selected uncompressed snapshot frame to the second memory device.

12. The method of claim 11, further comprising:
detecting a completion of the push of the capture-selected uncompressed snapshot frame to the second memory device; and
in response to detecting the completion of the push of the capture-selected uncompressed snapshot frame to the second memory device, ceasing generating the one or more votes.

13. The method of claim 12, further comprising:
in response to detecting the completion of the push of the capture-selected uncompressed snapshot frame to the second memory device, controlling the second memory device to operate according to a low performance frequency.

14. The method of claim 10, further comprising:
in response to receiving the capture command, controlling the second memory device to operate according to a high performance frequency.

15. An apparatus having digital camera capabilities, the apparatus comprising:
means for receiving, via camera hardware of the apparatus, a plurality of frames;
means for forming a plurality of uncompressed snapshot frames using a subset of the plurality of received frames;
means for storing the plurality of uncompressed snapshot frames to a buffer implemented in a first memory device of the apparatus;
means for receiving a capture command from a user input element, the capture command corresponding to user input;
means for identifying, in response to receiving the capture command, a first uncompressed snapshot frame of the plurality of uncompressed snapshot frames stored to the buffer implemented in the first memory device as a capture-selected uncompressed snapshot frame; and
means for pushing, in response to receiving the capture command, the capture-selected uncompressed snapshot frame to a second memory device of the apparatus, wherein the second memory device consumes greater power than the first memory device.

16. The apparatus of claim 15, further comprising:
means for generating, in response to receiving the capture command, one or more votes, the votes being associated with accessing the second memory device for pushing the capture-selected uncompressed snapshot frame to the second memory device that consumes greater power than the first memory device.

17. The apparatus of claim 16, further comprising:
means for detecting a completion of the push of the capture-selected uncompressed snapshot frame to the second memory device; and
means for ceasing, in response to detecting the completion of the push of the capture-selected uncompressed snapshot frame to the second memory device, generation of the one or more votes.

18. The apparatus of claim 16, further comprising:
means for controlling, in response to detecting the completion of the push of the capture-selected uncompressed snapshot frame to the second memory device, the second memory device to operate according to a low performance frequency.

19. The apparatus of claim 15, further comprising:
means for controlling, in response to receiving the capture command, the second memory device to operate according to a high performance frequency.

20. A non-transitory computer-readable storage medium encoded with instructions that, when executed, cause processing circuitry of a mobile computing device to:
receive, via camera hardware of a mobile computing device, a plurality of frames;
form a plurality of uncompressed snapshot frames using a subset of the plurality of the frames received by the camera hardware of the mobile computing device;
store the plurality of uncompressed snapshot frames to a buffer implemented in a first memory device of the mobile computing device;
receive a capture command from a user input element, the capture command corresponding to user input;
identify, in response to the receipt of the capture command, a first uncompressed snapshot frame of the plurality of uncompressed snapshot frames stored to the buffer implemented in the first memory device as a capture-selected uncompressed snapshot frame; and
push, in response to the receipt of the capture command, the capture-selected uncompressed snapshot frame to a second memory device of the mobile computing device, wherein the second memory device consumes greater power than the first memory device.
